(19) United States
(12) Patent Application Publication
(10) Pub. No.: US 2009/0313065 A1
(43) Pub. Date: Dec. 17, 2009

(54) SYSTEM AND TOOL FOR BUSINESS DRIVEN MANAGEMENT

(75) Inventors: Deaanne M. George, Freeburg, IL (US); Jill K. Goldstein, Fort Lauderdale, FL (US); Sian Beacham, Teddington (GB)

Correspondence Address: ACCENTURE CHICAGO 28164;BRINKS HOFER GILSON & LIONE, P O BOX 10395, CHICAGO, IL, 60610, US

(73) Assignee: ACCENTURE GLOBAL SERVICE GMBH, Schaffhausen (CH)

(21) Appl. No.: 12/332,082

(22) Filed: Dec. 10, 2008

Related U.S. Application Data
(60) Provisional application No. 61/131,890, filed on Jun. 13, 2008.

(51) Int. Cl. G06Q 10/00

(52) U.S. Cl. 705/7

(57) ABSTRACT

A system/tool/service for a business driven management is described. A strategic alignment is determined for a plurality of services. Demand planning is driven in accordance with the strategic alignment. Program execution and value measurement is outputted in accordance with the demand planning. Program execution and value measurement is applied to the strategic alignment determination.

### CROSS REFERENCE TO RELATED APPLICATION

This application claims the benefit of U.S. Provisional Application No. 61/131,890, filed Jun. 13, 2008, the entirety of which is incorporated by reference herewith.

### TECHNICAL FIELD

Generally a system, tool and platform are disclosed for business driven management, such as of talent, and related methods.

### BACKGROUND

Management of resources, such as business talent, may be important to a success of organizations, such as within today's modern global economy. Companies that operate in today's industries, some of which are complex, manage employees to serve the companies' evolving strategic objectives. Talent management may be a strategic objective of various businesses.

### BRIEF SUMMARY

A system/tool/service for a business driven management is described. A strategic alignment is determined for a plurality of services. Demand planning is driven in accordance with the strategic alignment. Program execution and value measurement is outputted in accordance with the demand planning. Program execution and value measurement is applied to the strategic alignment determination.

Other systems, methods, tools, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a block diagram of an overview for business driven management.

FIG. 2 is a block diagram of a strategic alignment.

FIG. 3 is a block diagram of processing program measures.

FIG. 4 is a block diagram to determine and maintain an overall strategic direction.

FIG. 5 is a block diagram of a framework to provide ongoing strategic leadership.

FIG. 6 is a block diagram to respond to client opportunities.

FIG. 7 is a block diagram to set direction for measurement programs.

FIG. 8 is a block diagram of assessing opportunity to provide increased value.

FIG. 9 is a block diagram for conducting innovation workshops.

FIG. 10 is a block diagram of demand planning.

FIG. 11 is a block diagram of collecting strategic planning information.

FIG. 12 is a block diagram of a complete market scan.

FIG. 13 is a block diagram to conduct planning session to outline service delivery strategy.

FIG. 14 is a block diagram to create a strategic plan and a ninety day plan.

FIG. 15 is a block diagram for completing the client service delivery strategy session.

FIG. 18 is a block diagram of a create budget profile per business unit area.

FIG. 19 is a block diagram for validating a strategic plan and updating a plan based on validation.

FIG. 20 is a block diagram for completing a final detailed review of a strategic plan with shared services teams to confirm it is executable.

FIG. 22 is a block diagram for managing the strategic plan sign-off by client stakeholders.

FIG. 23 is a block diagram for managing ongoing demand and maintaining the ninety day plan.

FIG. 24 is a block diagram for validating an existing ninety day plan.

FIG. 25 is a block diagram of a validate approach to address client opportunity.

FIG. 26 is a block diagram of a document change request and complete client review.

FIG. 27 is a block diagram of program execution and value measurement.

FIG. 28 is a block diagram of defined solutions and obtained statement of work approval.

FIG. 29 is a block diagram of obtained client approval on statement of work.

FIG. 30 is a block diagram to define needs, scope and statement of work.

FIG. 31 is a block diagram to manage introduction and enhancements to technologies.

FIG. 32 is a block diagram of consulting a service provider technical team regarding talent management related technology to offer the client.

FIG. 33 is a block diagram of managing a project lifecycle and project reporting.

FIG. 34 is a block diagram of implementing a new service or project.

FIG. 35 is a block diagram of coordinated AL/HR service provider service program efforts.

FIG. 36 is a block diagram to identify and launch necessary change management activities.

FIG. 37 is a block diagram of managing project reporting.

FIG. 38 is a block diagram of coordinating upload of knowledge capital, as appropriate.

FIG. 39 is a block diagram for managing relationships and ad hoc issues.

FIG. 40 is a block diagram for conducting internal cross-team meetings.

FIG. 41 is a block diagram for completing business measurement activities for selected projects.

FIG. 42 is a block diagram to design business measurement approach and activities.

FIG. 43 is a block diagram with regard to collecting measured data.

FIG. 44 is a block diagram to analyze business measurement data.

FIG. 45 is a block diagram for developing an executive summary report and presenting business measurement finding to clients.

FIG. 46 is a block diagram of an exemplary general computer system that may be used with to implement the systems, tools and methods of FIGS. 1-46.

### DETAILED DESCRIPTION

The systems, tools and methods may be used in different implementations, but for the sake of explanation, the systems methods and tools are described with regard to business talent management. The systems, methods, tools may be used to manage human resource outsourcing deals and provide targeted, strategic focus on impacting client business outcomes through strategic alignment, demand planning and value measurement. The systems, methods and tools may be used to strategically plan programs, measure value and drive innovation across each service area. Top-line conversations may enable business partners to identify opportunities where human resource can impact business outcomes. Return on investment data may be actively managed and business measurement studies administered, such as specific to high impact initiatives. Visibility to market data may be provided for industry analysis and insight, such as with regard to the impact to the client's business drivers. A structured approach to innovation may be introduced that supports the achievement of business goals, e.g., workshops and targeted conversations. Plans and account management aligned to business strategy may be delivered that identify integration points across services, such as to help ensure maximized business outcomes.

The systems, methods and tools may work alone or with other applications to manage expectations and incremental sales for strategic planning, and manage satisfaction, communication operations and people for demand planning and program execution/value measurement. The systems, methods and tools may determine and communicate client objectives. A direction for outsourcing may be determined in support of client business objectives. Cross-service opportunities to maximize outsourcing impact may be identified, and innovation efforts, such as innovation efforts, driven. Measurement approach may be established to ensure achievement of business goals. Ad hoc issue resolution impacting achievement of business goals may be assisted. Strategic plans, such as account plans, may be created and managed, and a second plan may be based on the strategic plan, such as ninety day ongoing plans, or for other time periods. The systems, methods and tools may manage business measurement studies, overall measurement approach, and reporting of business objectives. The systems, methods and tools may be used in performance feedback and engagement initiatives, and team members may be managed.

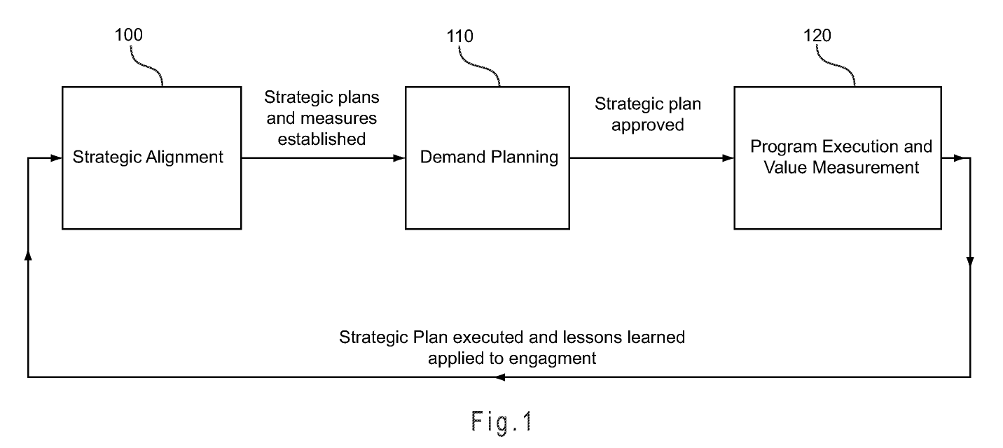

FIGS. 1-45 are block diagrams/flow charts of systems, tools and methods, generally referred to herein as systems, for business driven management, such as management of talent. In FIG. 1, the systems, tools and methods include strategic alignment 100, demand planning 110 and program execution and value management 120. With strategic alignment 100, strategic plans and measures may be established which are provided to the demand planning 110. From demand planning 110, the strategic plan may be approved and sent for program execution and value measurement 120. With program execution and value measurement, the strategic plan may be executed and lessons learned applied to engagement, which may be fed back to strategic alignment 100.

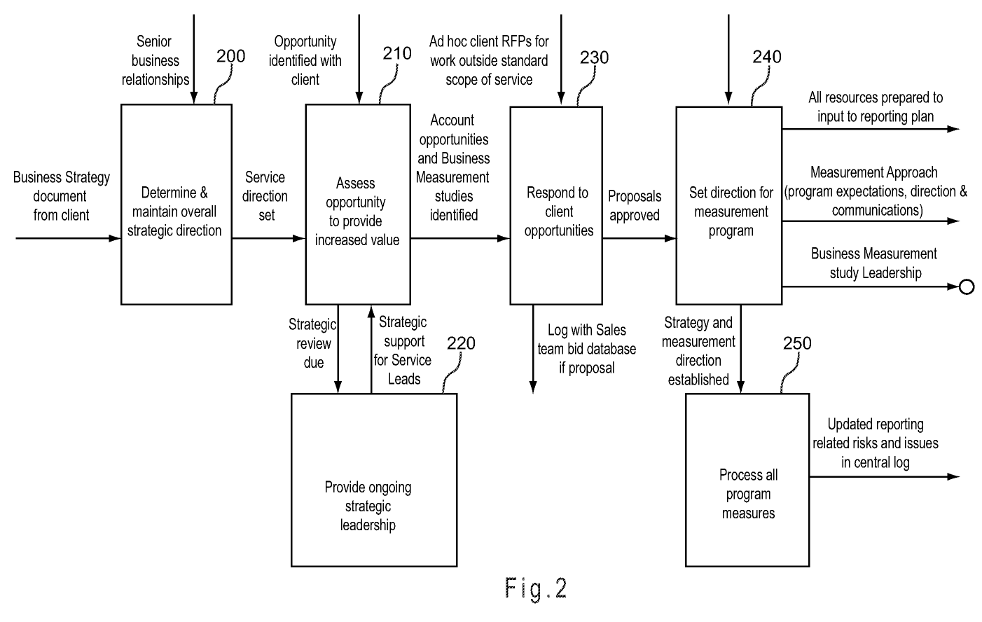

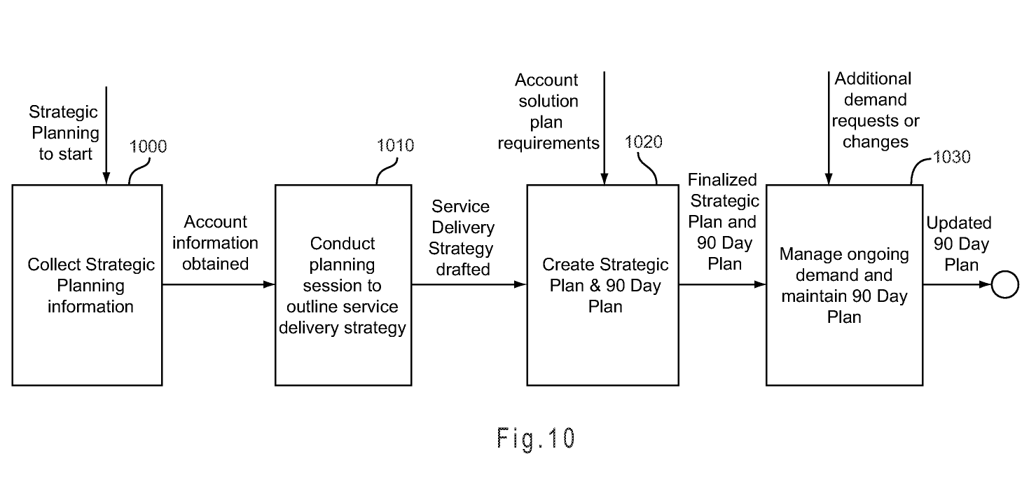

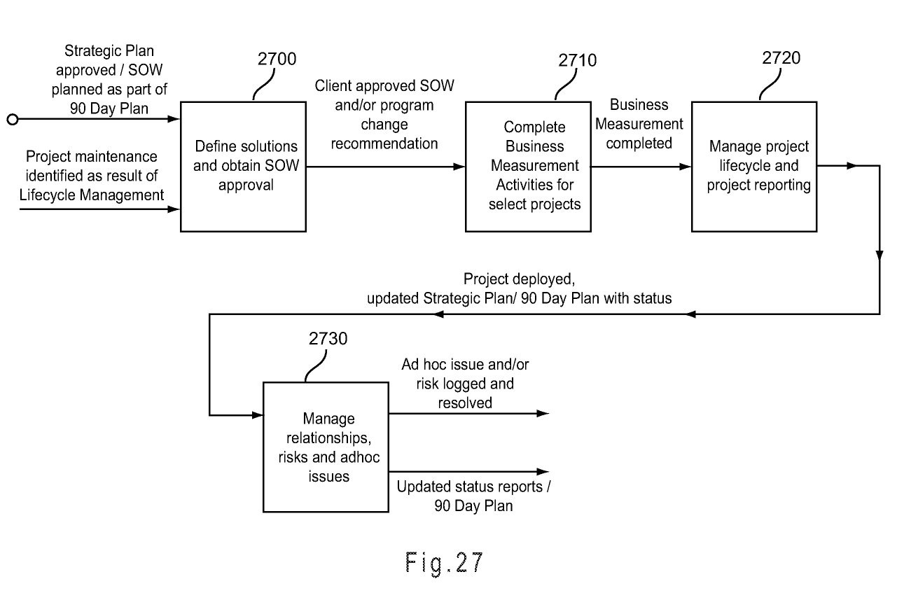

FIGS. 2-9 generally relate to strategic alignment 100, FIGS. 10-26 relate to demand planning 110, and FIGS. 27-45 relate to execution and value management 120. The system may include/utilize processes/services/systems/tools that are part of an overall scope of a business plan, such as Business Interlock (BI) manufactured by Accenture, for example one described in commonly assigned U.S. Patent Application Publication Nos. 2004/0002888, filed Jan. 1, 2004, and 2008/0021769, filed Jan. 24, 2008, which are incorporated by reference herein.

In FIG. 2, at block 200, senior business relationships and business strategy documents from the client may be used to determine and maintain an overall strategic direction. When a service direction is set, at block 210 the system assesses opportunities to provide increased value in accordance with opportunities identified with the client. At block 220, ongoing strategic leadership is provided in accordance with a strategic review from the accessed opportunities 210 and strategic support for service leads is returned. From the assessed opportunities, at block 230, identified account opportunities and business measurement studies are sent to respond to client opportunities. Client request for proposals, such as for ad hoc work outside a standard scope of service may also be addressed. Unsuccessful sales team bids may be stored in a log.

At block 240, approved proposals may be set for a measurement program. A measurement program or strategy may include the service provider setting forth a structured plan for how the interventions and work being accomplished are measured. This may ensures a comprehensive focus which brings to light service level agreements, common industry measures, specific business measurement studies, and other elements appropriate to demonstrate impact on business objectives. Resources may be prepared to input to a reporting plan. A measurement approach may be established, such as in terms of program expectation, direction and communications. As a strategy and measurement direction is established, at block 250 the program measures may be processed. Updated reporting, related risks and any related issues may be stored in a log, which may be centralized.

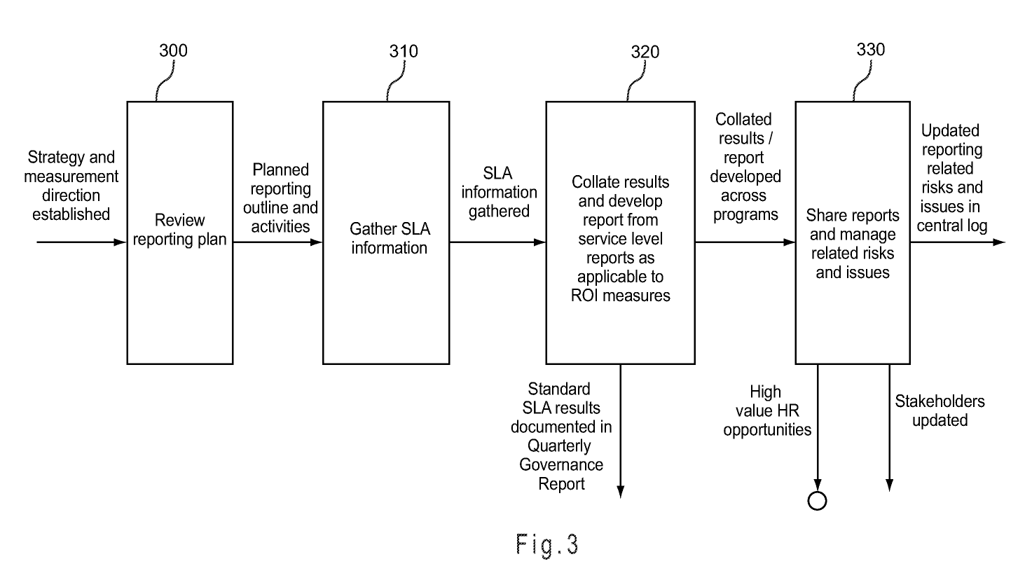

FIG. 3 is a block diagram of processing program measures. At block 300, the reporting plan may be reviewed in accordance with the established measurement strategy and direction. At block 310, service level agreements (SLA) may be gathered based on a planned outline and activities from the reviewed reporting plan. At block 320, results may be collated and reports developed from the service level reports as applicable to return on investment (ROI) measures. SLA results may be documented, such as in quarterly governance reports. At block 330, reports are shared and related risks and issues may be managed from the collated results and reports developed across programs. The updated reporting related risks and issues may be stored in the central log. High value human resource (HR) opportunities may be outputted and stakeholders may be updated.

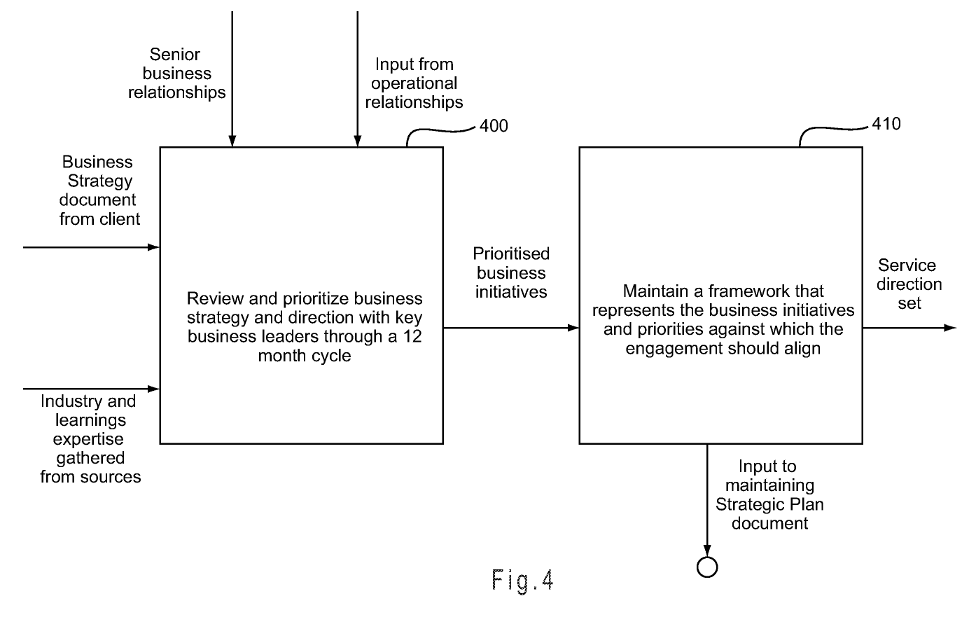

FIG. 4 is a block diagram to determine and maintain an overall strategic direction. At block 400, a business strategy and direction may be reviewed and prioritized with appropriate business leaders through a determined time period, such as a twelve month cycle. The business strategy and direction may take into account one of more of industry and learning gathered from sources, business strategy documents from clients, senior business relationships, and input from operational relationships. At block 410, a framework may be maintained that represents business initiatives and priorities against which the engagement should align. Prioritized business initiatives may be inputted to maintain the framework and service directions and inputs to maintaining the strategic plan document may be output.

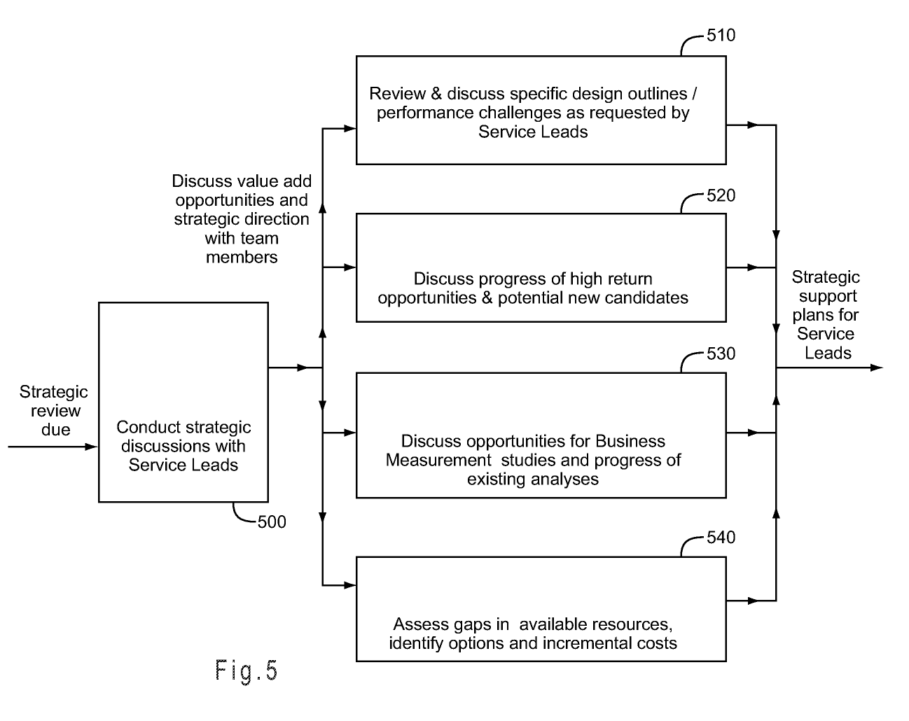

FIG. 5 is a block diagram of a framework to provide ongoing strategic leadership. At block 500, when a strategic review is due, strategic discussions may be conducted with service leads. At block 510, determined design outlines and performance challenges as requested by service leads may be reviewed and discussed. Value add opportunities and strategic direction with team members by be discussed. At block 520, progress of high return opportunities and potential new candidates may be discussed. At block 530, opportunities for business measurement studies and progress of existing analyses may be discussed. At block 540, gaps in available resources may be assessed and options and incremental costs identified. Strategic support plans for service leads may be output.

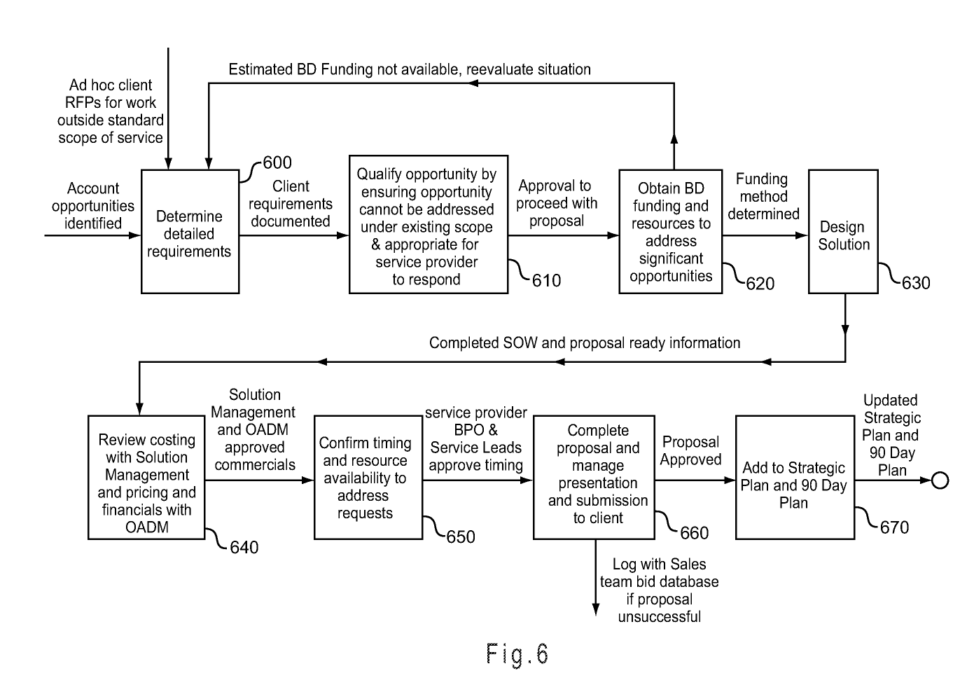

FIG. 6 is a block diagram to respond to client opportunities. At block 600, detailed requirements may be determined from ad hoc client RFP's for work outside a standard scope of service and from identified account opportunities. Client requirements may be documented. At block 610, opportunities may be qualified by ensuring the opportunity cannot be addressed under an existing scope and appropriate for service provider to respond. At block 620, when approved to proceed with the proposal, business development (BD) funding and resources are obtained to address significant opportunities. If an estimated business development funding is not available, at block 610 the requirements are reevaluated. At block 630, if a funding method is determined, a solution is designed. Completed statement of work and proposal ready information is outputted. At block 640, costing is reviewed with solution management and pricing and financials are reviewed with account management (OADM). At block 650, for solution management and account management approved commercials, timing and resource availability is confirmed to address requests. At block 660, if the service provider and service leads approve timing, the proposal may be completed and the presentation and submission to the client are managed. If the proposal is unsuccessful, the unsuccessful proposal may be logged with the sales team bid database. At block 670, if the proposal is approved, the proposal may be added to the strategic plan and second plan related to the strategic plan, where the second plan may include a ninety day plan. An updated strategic plan and ninety day plan may be stored.

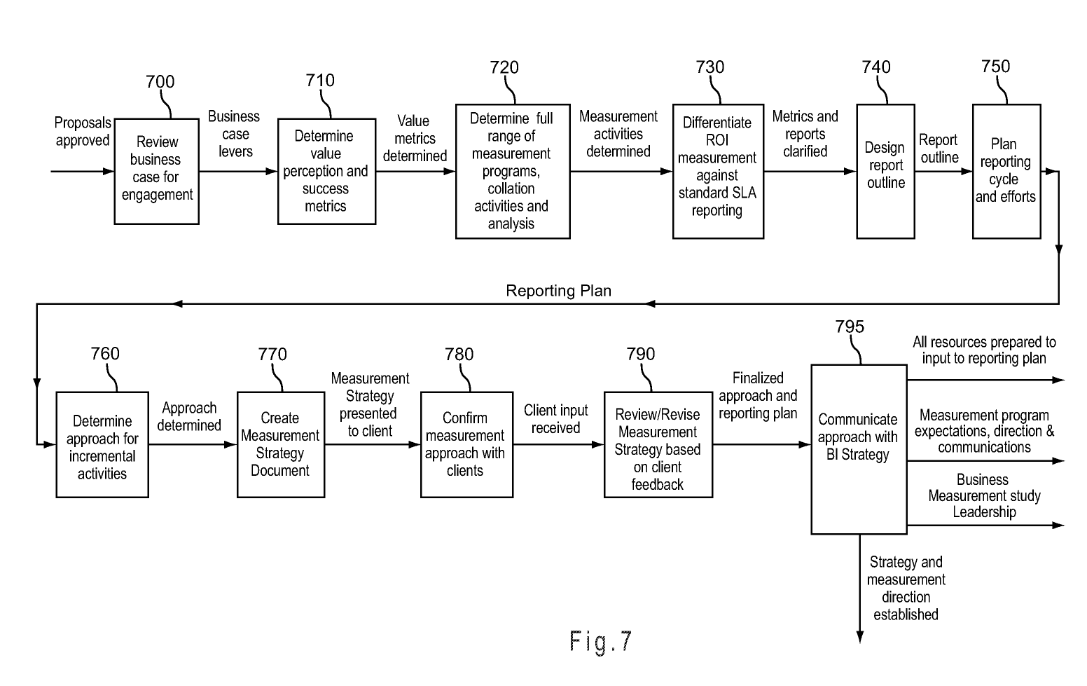

FIG. 7 is a block diagram to set direction for measurement programs. At block 700, with approved proposals, a business case for engagement with the client is reviewed. At block 710, using business case levers, value perception and success metrics are determined. At block 720, with the determined value metrics, a full range of measurement programs, collation activities and analysis may be determined. At block 730, after measurement activities are determined, the ROI measurement may be differentiated against standard SLA reporting. At block 740, with metrics and reports clarified, a report outline may be designed. At block 750, using the reporting outline, reporting cycles and efforts may be planned. At block 760, an approach for incremental activities may be determined. At block 770, with the determined approach, measurement strategy documents may be created. At block 780, when the measurement strategy is presented to the client, the measurement approach may be confirmed with the client. At block 790, with client input received, the measurement strategy may be reviewed and revised based on client feedback. At block 795, a finalized approach and reporting plan may be communicated with business interlock (BI) strategy. Information communicated may include one or more of all resources prepared to input to the reporting plan, measurement program expectation, direction and communications, business measurement study leadership, and the established strategy and measurement direction.

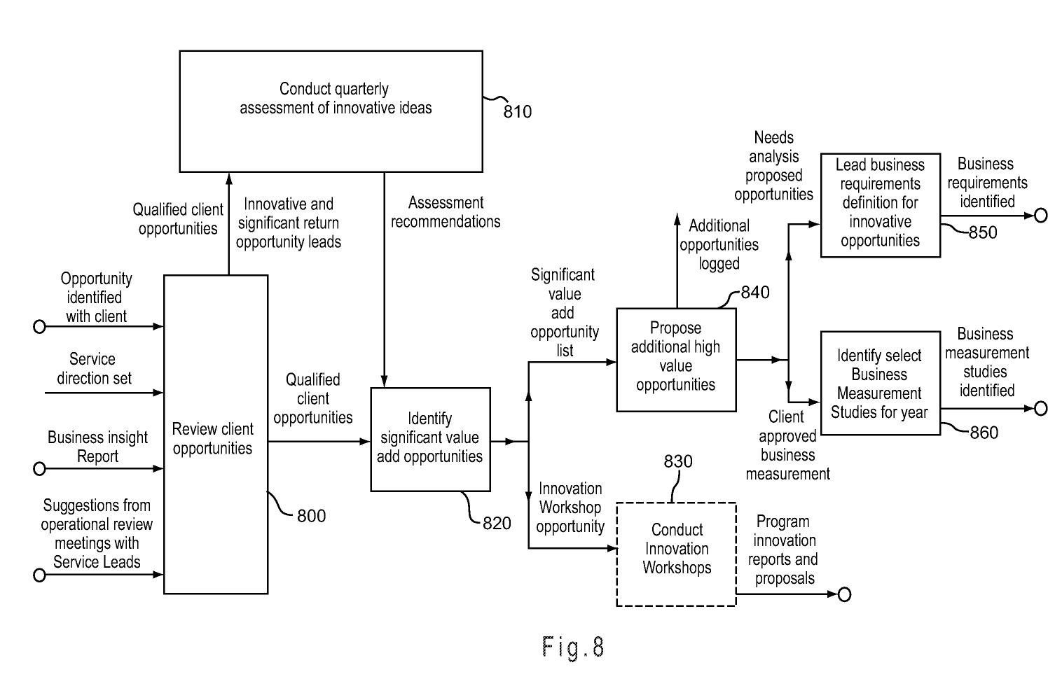

FIG. 8 is a block diagram of assessing opportunity to provide increased value. At block 800, client opportunities may be reviewed. The reviewed opportunities may be opportunities identified with clients, service direction sets, from business insight reports and suggestions for operational review meeting with service leads. At step 810, qualified client opportunities, such as innovative and significant return opportunity leads from the review of client opportunities, may also be considered in the assessment of innovative ideas. The innovative ideas may be assessed periodically, such as every quarter of the year. At block 820, significant value add opportunities are identified based on assessment recommendations and qualified client opportunities. At block 830, innovation workshops may be conducted based on identified innovation workshop opportunities, which may produce program innovation reports and proposals. At block 840, additional high value opportunities may be proposed base on significant value add opportunities, and the additional opportunities may be logged. At block 850, lead business requirements may be defined for innovative opportunities based on a needs analysis for proposed opportunities, to identify business requirements. At block 860, select business measurement studies for the year may be identified based on client approved business measurement, to identify business measurement studies.

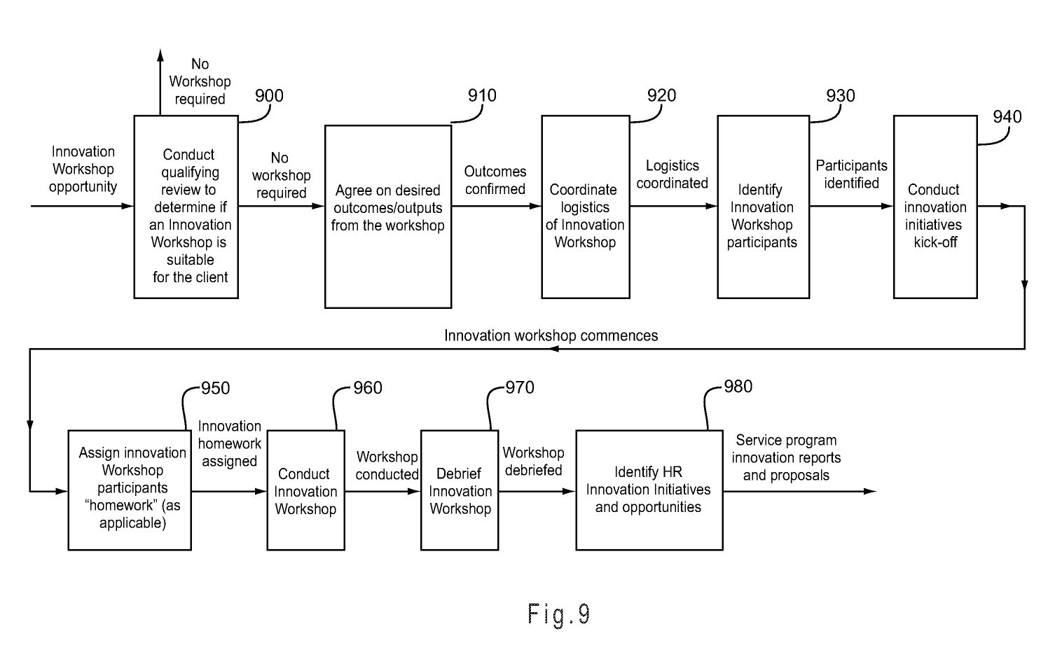

FIG. 9 is a block diagram for conducting innovation workshops. At block 900, quality review may be conducted to determine if an innovation workshop is suitable for the client, such as in accordance with identified innovation workshop opportunities. If a workshop is not required, none is held. Targeted discussions may be held instead, such as due to client size, relationship and acceptance of innovation. At block 910, desired outcomes and outputs from the workshops are agreed on for required workshops. At block 920, logistics of the innovation workshop are coordinated after the outcomes are confirmed. At block 930, innovation workshop participants are identified when the logistics are coordinated. At block 940, an innovation initiative kick-off is conducted after participants are identified. At block 950, innovation workshop participants are assigned homework as required. At block 960, the innovation workshop may be conducted after the homework is assigned. At block 970, an innovation workshop debriefing may occur after the workshop is conducted. At block 980, HR innovation initiatives and opportunities may be identified after the workshop debriefing. Service programs innovation reports and proposals may result.

FIG. 10 is a block diagram of demand planning. At block 1000, strategic planning information may be collected. At block 1010, a planning session to outline a service delivery strategy may be conducted periodically in accordance with obtained account information. Demand planning may occur about once a year, for an upcoming client fiscal year for client business objectives. In addition, ninety day plans may be used in the interim. Other planning periods may be used depending on a business and needs of the client. At block 1020, a strategic plan and ninety day plan are created in accordance with drafted service delivery strategy and account solution plan requirements. At block 1030, ongoing demand may be managed and ninety plans maintained based on finalized strategic plans and ninety day plans, and additional demand requests for changes. Updated ninety day plans may result from the maintaining the plans.

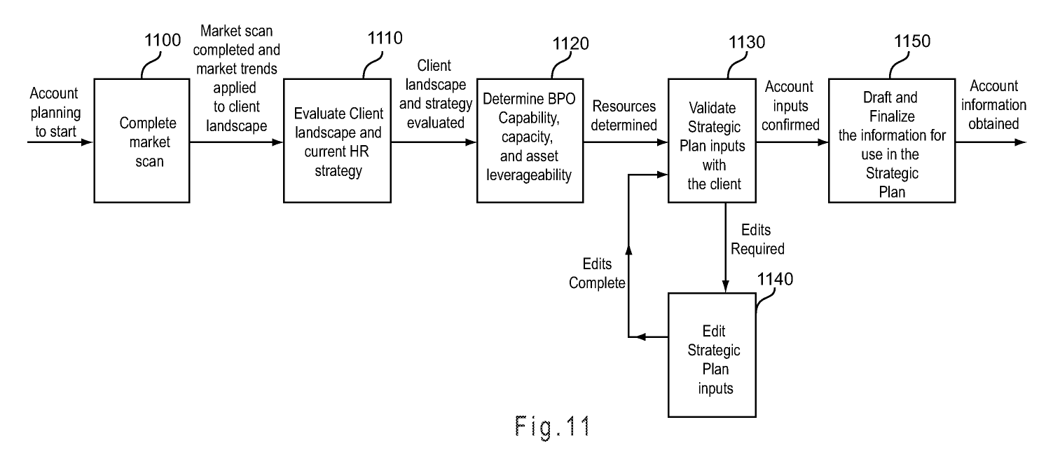

FIG. 11 is a block diagram of collecting strategic planning information. At block 1100, a market scan is completed in accordance with account planning. At block 1110, a client landscape and current HR strategy is evaluated based on the completed market scan and market trends applied to the client landscape. At block 1120, the service provider capability, capacity, and asset leveragability is determined in accordance with the client landscape and evaluated strategy. At block 1130, strategic plan inputs are validated with the client in accordance with determined resources. At block 1140, if edits are required, strategic plan inputs are edited and sent for validation. At block 1150, information for use in the strategic plan are drafted and finalized based on confirmed account inputs. Account information is outputted.

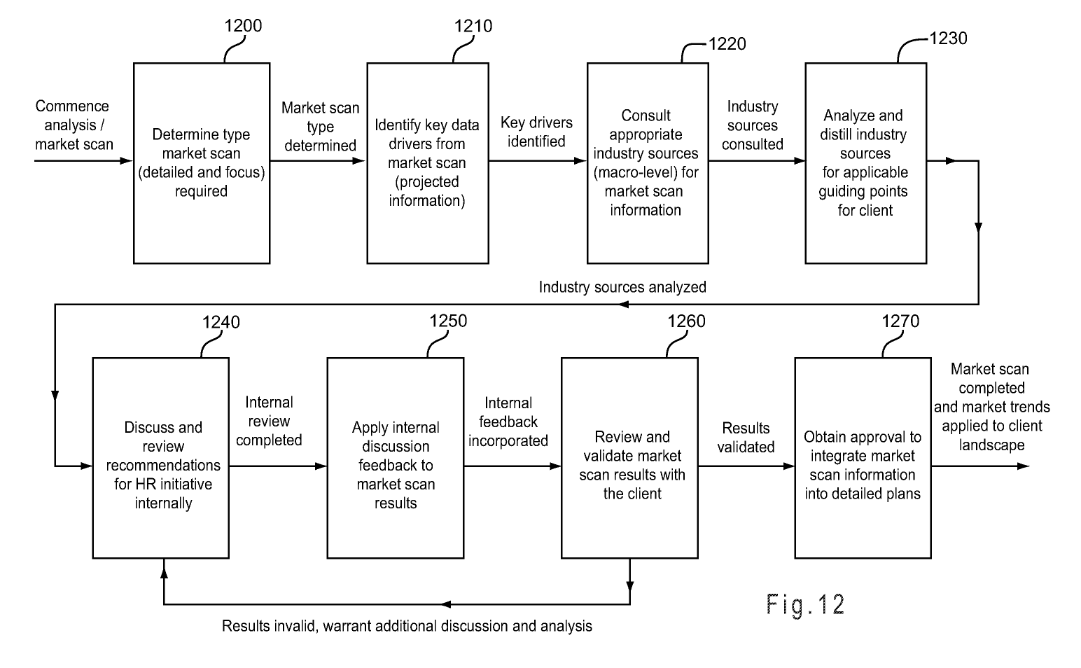

FIG. 12 is a block diagram of a complete market scan. At block 1200, a required type of market scan is determined in terms of detail and focus. At block 1210, key data drivers from market scan are identified for projected information. At block 1220, industry sources may be consulted, such as at a macro-level, for market scan information based on identified key drivers. At block 1230, industry sources for applicable guiding points are analyzed and distilled for clients in accordance with the industry sources consulted. At block 1240, recommendation for HR initiatives are discussed and reviewed internally. At block 1250, internal discussion feedback to market scan results is applied based on the completed internal review. At block 1260, market scan results are reviewed and validated with the client in accordance with incorporated internal feedback. Invalid results that warrant additional discussion and analysis are further discussed and reviewed at block 1240. At block 1270, Approval is obtained to integrate market scan information into detailed plans for validated results. Thereafter, the market scan is completed and market trends are applied to the client landscape.

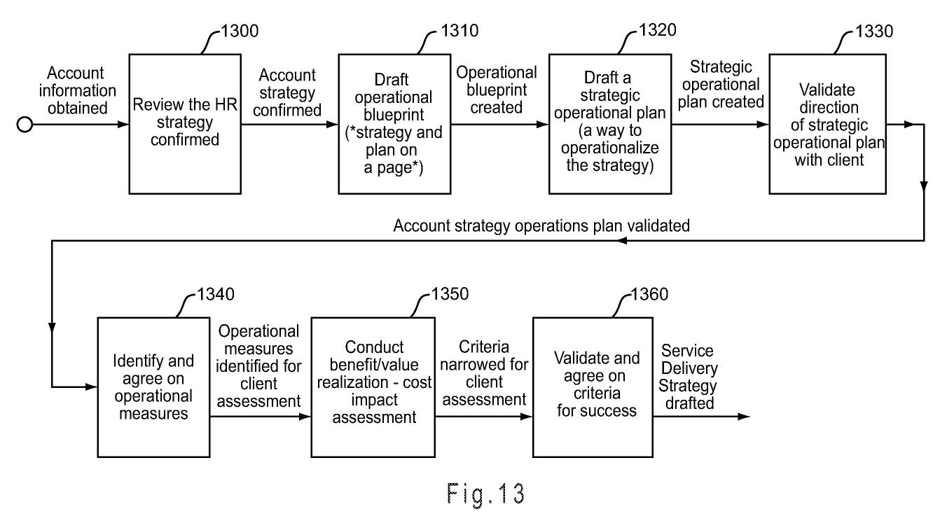

FIG. 13 is a block diagram to conduct planning session to outline service delivery strategy. At block 1300, the HR strategy is reviewed in accordance with obtained account information. At block 1310, operational blueprints are drafted for strategy and plan on a page base on confirmed account strategy. At block 1320, a strategic operational plan is drafted, such as for a way to operate the strategy, in accordance with the created operational blueprint. At block 1330, a direction of the strategic operational plan is validated with the client in accordance with the created strategic operation plan. At block 1340, operational measures are identified and agreed on. At block 1350, benefit and value realization and cost impact assessment is conducted in accordance with operational measures identified for client assessment. At block 1360, criteria for success is validated and agreed on based on criteria narrowed for client assessment. Thereafter, a service delivery strategy is drafted.

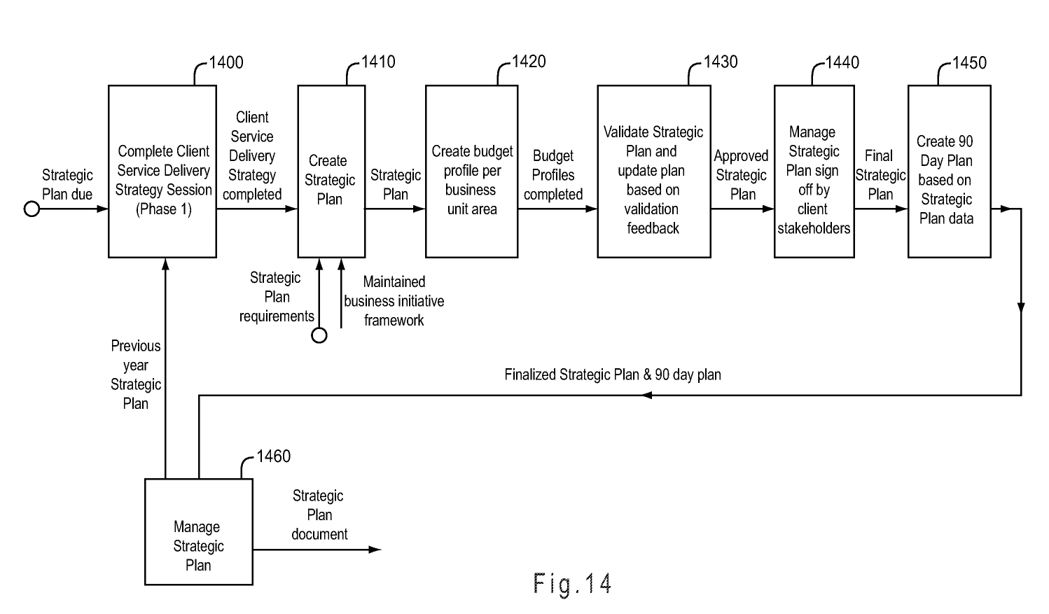

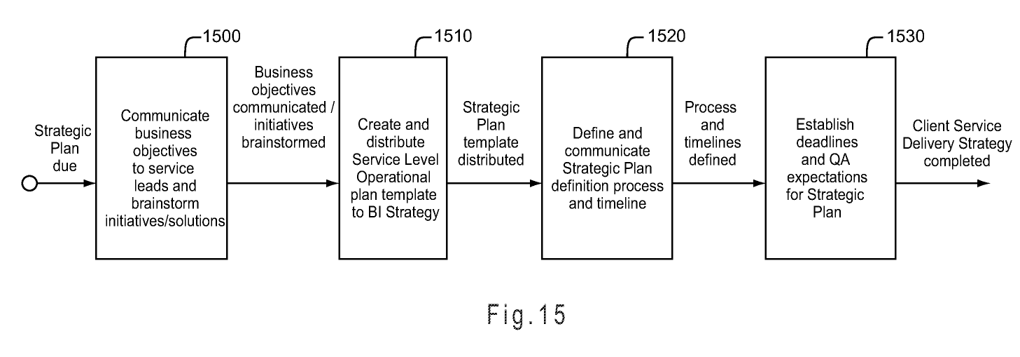

FIG. 14 is a block diagram to create a strategic plan and a ninety day plan. At block 1400, a client service delivery strategy session is completed when the strategic plan is due. At block 1410, the strategic plan is created in accordance with strategic plan requirement, maintained business initiative framework and the completed client service delivery strategy. At block 1420, a budget profile is created per business unit area based on the strategic plan. At block 1430, the strategic plan is validated and the plan is updated based on validation feedback when the budget profiles are completed. At block 1440, the strategic plan sign off is managed by client stakeholders for the approved strategic plan. At block 1450, the ninety day plan is created based on strategic plan data from the final strategic plan. At block 1460, the strategic plan is managed, the previous year strategic plan is sent to the client delivery strategy session and a strategic plan document is produced.

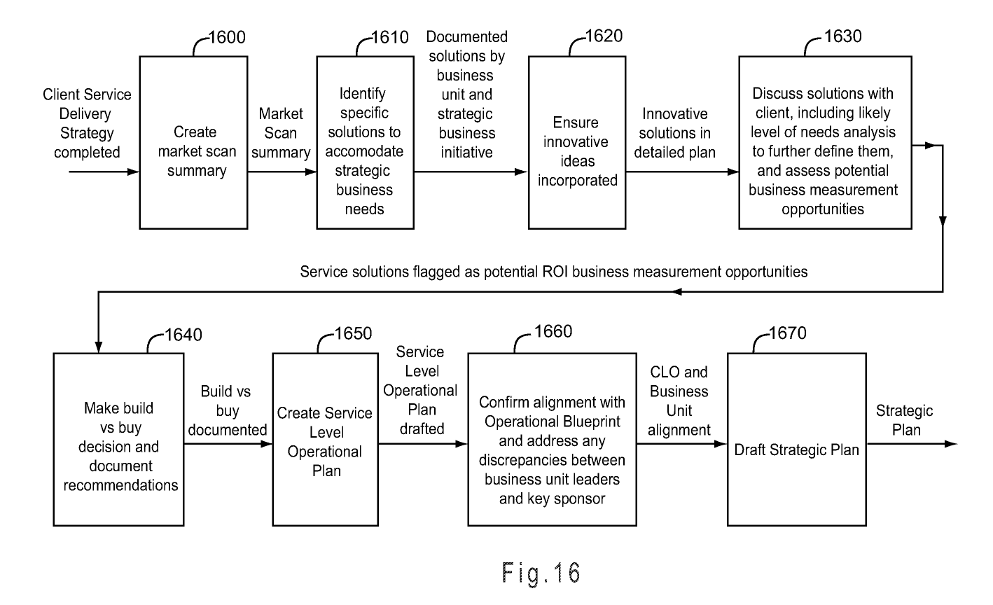

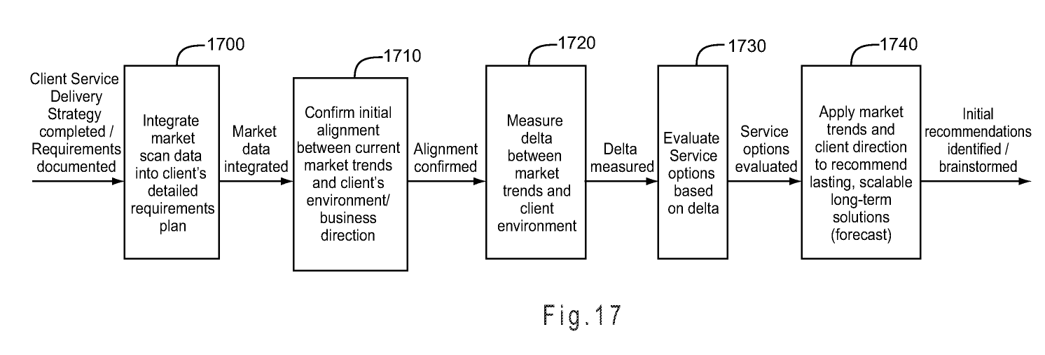

FIG. 15 is a block diagram for completing the client service delivery strategy session. At block 1500, business objectives are communicated to service leads and initiatives and solutions are brainstormed when the strategic plan is due. At block 1510, a service level operational plan template is created and distributed to business interlock strategy after the business objectives are communicated. At block 1520, a strategic plan definition process and timeline are defined and communicated for the distributed strategic plan template. At block 1530, deadlines and quality expectations for the strategic plan are established for defined process timelines. Thereafter, the client service delivery strategy is completed.

FIG. 16 is a block diagram for creating a strategic plan. At block 1600, a market scan summary is created for the completed client service delivery strategy. At block 1610, specific solutions are identified to accommodate strategic business needs in accordance with the market scan summary. At block 1620, solutions are documented by business unit and strategic business initiative to ensure innovative ideas are incorporated. At block 1630, solution are discussed with the client, including likely level of needs analysis to further define them, and assess potential business measurement opportunities for the innovative solutions in the detailed plan. At block 1640, build versus buy decisions are made and recommendations documented for service solutions flagged as potential ROI business measurement opportunities. At block 1650, a service level operational plan is created. At block 1660, alignment with the operational blueprint is confirmed any discrepancies are addressed between business unit leaders and key sponsors for the drafted service level operational plan. At block 1670, the strategic plan is drafted in accordance with business unit alignment.

FIG. 17 is a block diagram for creating a market scan summary. At block 1700, market scan data is integrated into client's detailed requirements plan for a completed client service delivery strategy and documented requirements. At block 1710, initial alignment is confirmed between current market trends and a client's environment and business direction. At block 1720, the difference between market trends and client environment is measured for the confirmed alignment. At block 1730, service options are evaluated based on the measured delta. At block 1740, market trends and client direction are applied to recommend lasting, scalable long-term forecasted solutions for evaluated service options. Initial recommendation are identified and brainstormed.

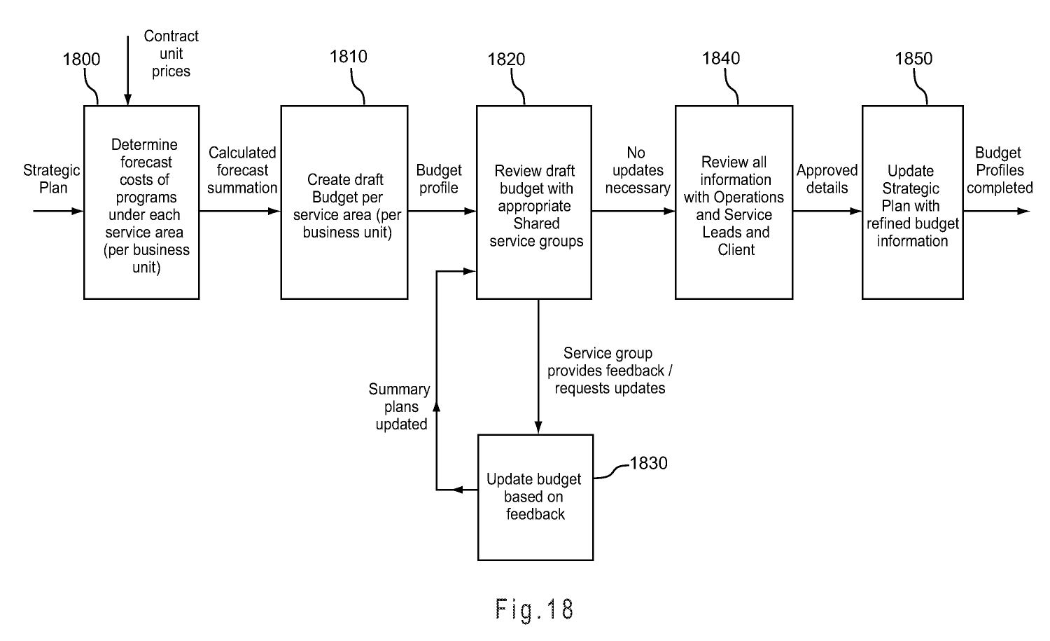

FIG. 18 is a block diagram for creating a budget profile per business unit area. At block 1800, forecast costs of programs are determined under each service area, such as per business unit, for the strategic plan and contract unit prices. At 1810, a draft budget per service area is created, such as per business unit, for the calculated forecast summation. At block 1820, a draft budget is reviewed with appropriate shared service groups for the budget profile. At block 1830, the budget is updated based on feedback provided from the service group and requested updates. Updated summary plans are sent to be reviewed at block 1820. At block 1840, all information is reviewed with operations, service leads and clients when not updated are necessary. At block 1850, the strategic plan is updated with refined budget information for approved details, and the budget profiles are completed.

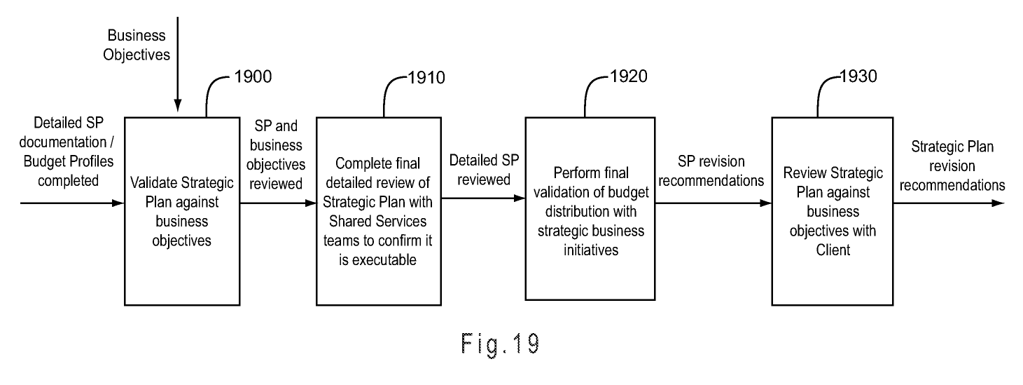

FIG. 19 is a block diagram for validating a strategic plan and updating a plan based on validation. At block 1900, the strategic plan is validated against business objectives in accordance with detailed strategic plan (SP) documentation, completed budget profiles and business objectives. At block 1910, a final detailed review of the strategic plan is completed with shared services teams to confirm it is executable in accordance with reviewed strategic plan and business objectives. At block 1920, a final validation of budget distribution is performed with strategic business initiatives based on the reviewed detailed strategic plan. At block 1930, the strategic plan is reviewed with the client against business objectives, in accordance with strategic plan revision recommendations. Strategic plan revision recommendations are output.

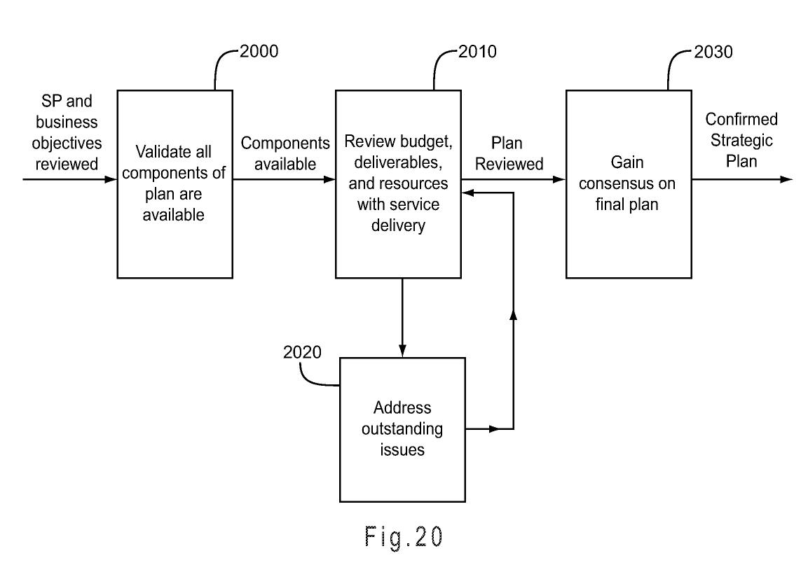

FIG. 20 is a block diagram for completing a final detailed review of a strategic plan with shared services teams to confirm it is executable. At block 2000, strategic planning business objectives are reviewed and it is validated that all components of the plan are available. At block 2010, for available components, the budget, deliverables, and resources are reviewed with service delivery. At block 2020, any outstanding issues are addressed. At 2030, a consensus on the final plan is gained, and the strategic plan confirmed.

FIG. 21 is a block diagram for performing final validation of budget distribution with strategic business initiatives. At block 2100, a total spend against weighted business initiatives is determined for services confirmation. At block 2110, spend spread is analyzed and recommendations to address are made for the spend report. Strategic plan revision recommendation is output.

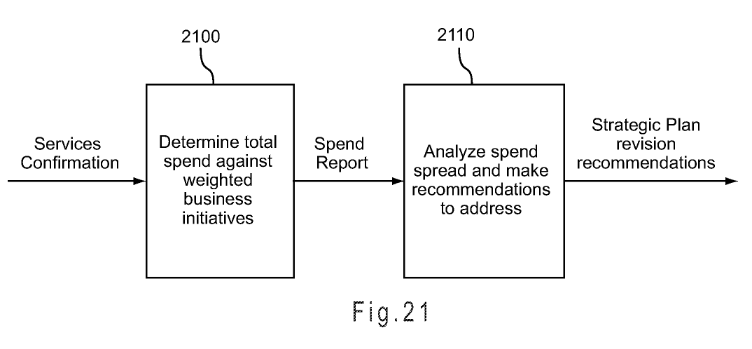

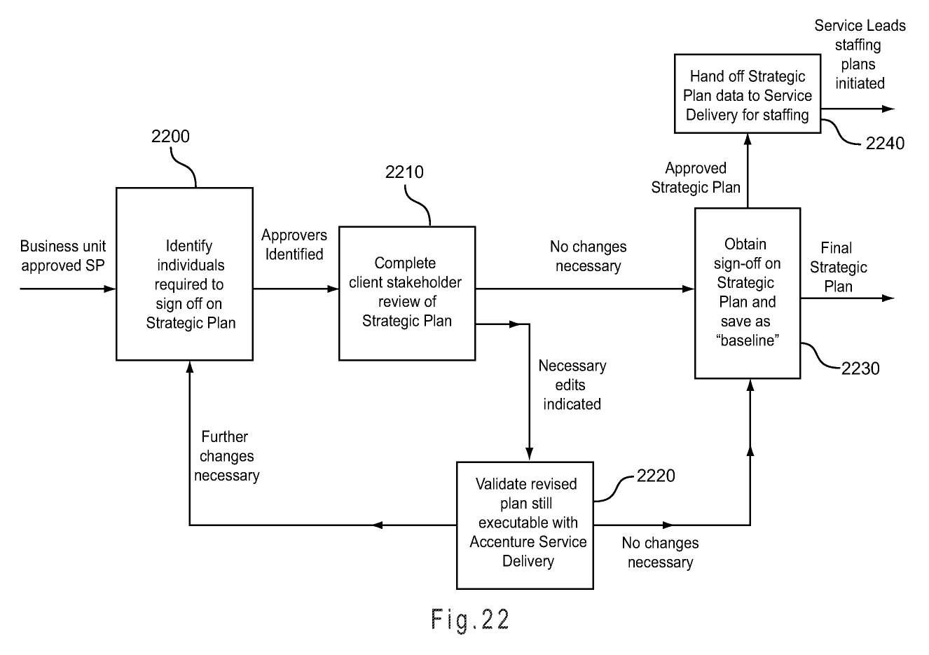

FIG. 22 is a block diagram for managing the strategic plan sign-off by client stakeholders. At block 2200, individuals required to sign off on the strategic plan are identified in accordance with the business unit approved strategic plan. At block 2210, a client stakeholder view of the strategic plan is completed with identified approvers. At block 2220, if edits are necessary, the revised plan is validated as still being executable with service delivery, and further necessary changes are sent to be reviewed at block 2210. At block 2230, if no changes are necessary, sign-off is obtained on the strategic plan and saved as a baseline. At block 2240, the approved strategic plan data is handed off to service delivery for staffing. Service leads and staffing plans are initiated.

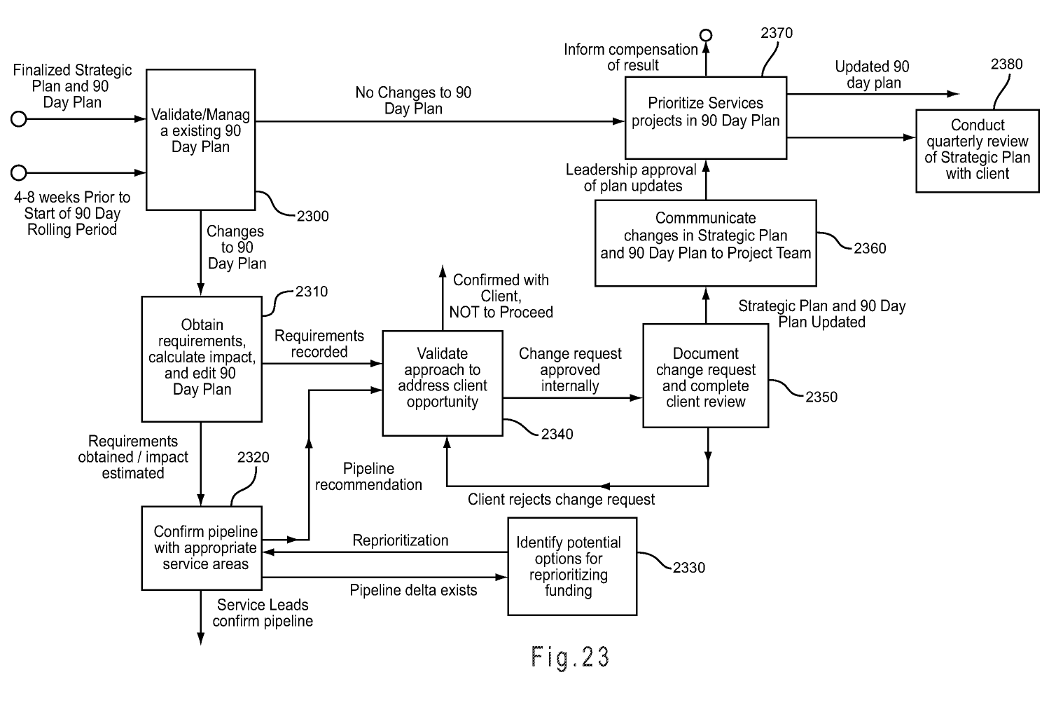

FIG. 23 is a block diagram for managing ongoing demand and maintaining the ninety day plan. At block 2300, the existing ninety day plan is validated and managed, such as four to eight weeks prior to the starting of the ninety day rolling period. At block 2310, requirements are obtained, impact is calculated and then ninety day plan is edited with determined changes to the ninety day plan. At block 2320, work pipelines are confirmed with appropriate service areas based on obtained requirements and estimated impact. At block 2330, potential options for reprioritizing funding are identified if a difference in the pipeline exists. At block 2340, the approach to address client opportunity is validated in accordance with pipeline recommendations and recorded requirements. At block 2350, if the client confirms to proceed, change requests are processed and client review completed. If the client rejects the change request, the approach is validated again with the client at block 2340. At block 2360, changes in the strategic plan and ninety day plan are communicated to the project team. At block 2370, services in the ninety day plan are prioritized and compensation is informed of the result. An updated ninety day plan is outputted, and at block 2380 the strategic plan is updated quarterly with the client.

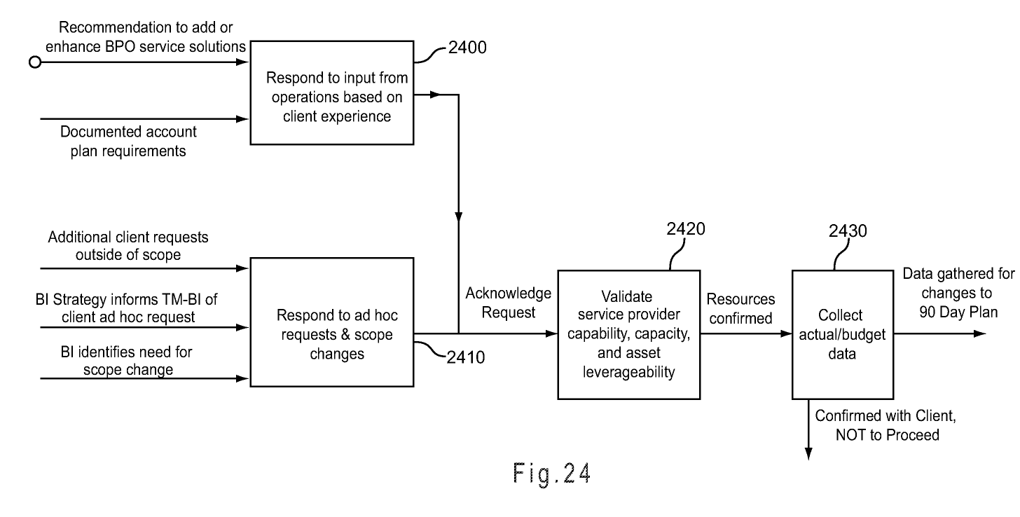

FIG. 24 is a block diagram for validating an existing ninety day plan. At block 2400, input from operation is responded to in accordance with client experience, documented account requirements and recommendation to add or enhance the service provider service solutions. At block 2410, ad hoc requests and scope changes are responded to in accordance with additional client request outside the scope, business interlock strategy informed talent management-business interlock of client ad hoc requests and business interlock identified need for scope change. At block 2420, service provider capability, capacity and asset leverage is validated for the acknowledge request. At block 2430, actual and budget data is collected in accordance with confirmed resources. Data is gathered for changed to the ninety day plan.

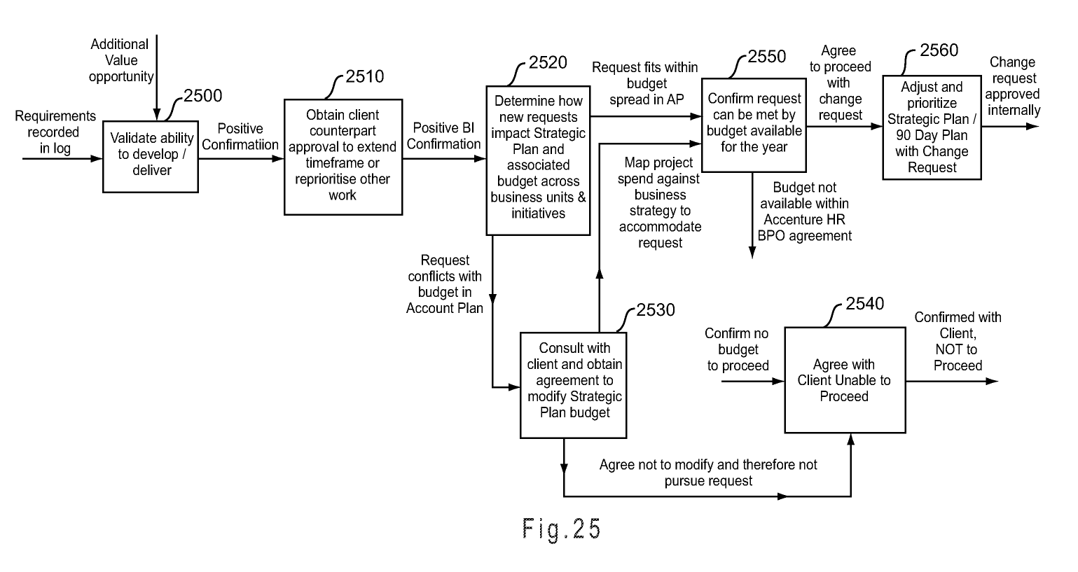

FIG. 25 is a block diagram of a validate approach to address client opportunity. At block 2500, the ability to develop and deliver are validated based on requirements recorded in the log and the additional value opportunities. At block 2510, client counterpart approval may be obtained to extend the timeframe or reprioritize other work for positive confirmations. At block 2520, how new request impact the strategic plan is determined with associated budget across business units and initiatives for positive business interlock confirmation. At block 2530, the client is consulted with and an agreement to modify the strategic plan budget is obtained when the request conflicts with budget in the account plan. At block 2540, the service provider may agree with the client that they are unable to proceed if there is confirmation that there is no budget to proceed or an agreement not to modify and therefore not pursue the request. At block 2550, the service provider may confirm that the request can be met by the budget available for the year when the request fits within the budget spread in the account plan (AP) or the project spend is mapped against business strategy to accommodate the request. At block 2560, the strategic plan and ninety day plan may be adjusted and prioritized with a change request if the client agrees to proceed with the change request. Otherwise it is determined that the budget is not available within the service provider HR service provider agreement.

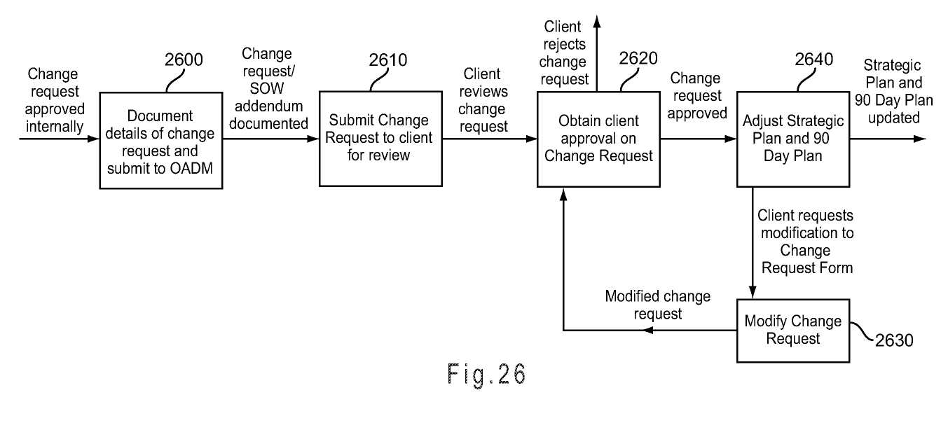

FIG. 26 is a block diagram of a document change request and complete client review. At block 2600, when a change request in internally approved, details of the change request are documented and submitted to account management. At block 2610, the change request is submitted to the client for review in accordance with the change request and a documented statement of work addendum. At block 2620, client approval/disapproval on the change is obtained after the client reviews the change request. Additionally, at block 2630, the client may request modification to the change request form. A modified change request form may then be submitted to the client for review at block 2610. At block 2640, if the client approves the requested change, the strategic plan and the ninety day plan may be adjusted and updated accordingly.

FIG. 27 is a block diagram of program execution and value measurement. At block 2700, solutions are defined and statement of work approval obtained for the approved strategic plan, statement of work planned as part of the ninety day plan, and project maintenance identified as a result of lifecycle management, such as of the life of the service or capability. At block 2710, business measurement activities are completed for select projects based on client approved statement of work and/or program change recommendations. At block 2720, the project lifecycle and project reporting are managed when the business measurement is completed. At block 2730, as the project is deployed and the strategic plan and ninety day plans updated with status, relationships, risks and ad hoc issues are managed. Ad hoc issues and/or risk may be logged and resolved. The status reports and ninety plans may be updated.

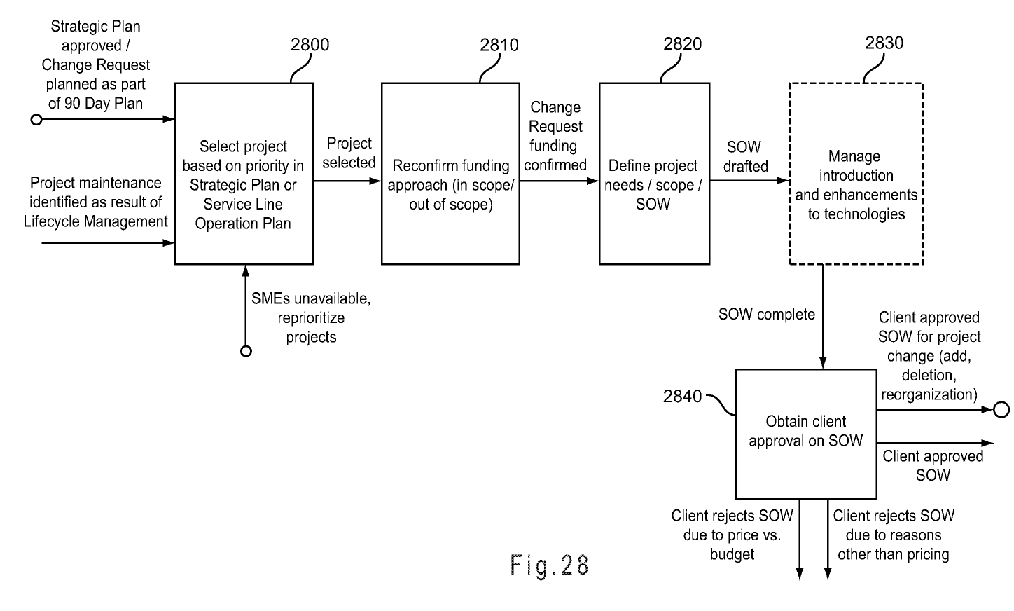

FIG. 28 is a block diagram of defined solutions and obtained statement of work approval. At block 2800, a project is selected based on priority in the strategic plan or service line operation plan for the approved strategic plan, change request planned as part of the ninety day plan, reprioritized projects for unavailable subject matter experts (SME), and project maintenance identified as a result of Lifecycle Management. At block 2810, the funding approach is confirmed as being in scope or out of scope for the selected project. At bock 2820, project needs, scope and statement of work are defined for the confirmed change request funding. At block 2830, the statement of work is drafted and the introduction and enhancements to technologies are managed. At block 2840, when the statement of work is completed, client approval for the statement of work is obtained. The client may approve the statement of work, approve the statement of work for project changes (add, deletion, reorganization), reject the statement of work due to price and budget, or reject the statement of work due to reasons other than pricing.

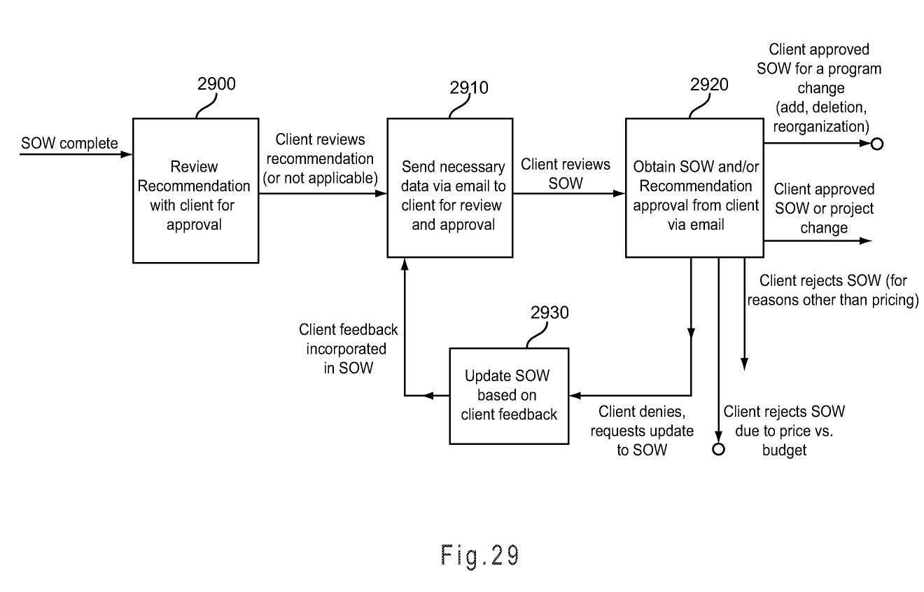

FIG. 29 is a block diagram of obtained client approval on statement of work. At block 2900, when the statement of work is complete, recommendations are reviewed for client approval. At block 2910, necessary data may be sent by email to the client for review and approval, such as after the client reviews recommendations, if applicable. At block 2920, statement of work and/or other recommendation approval are obtained from the client via email or in other ways for client reviewed statement of work. The client may approve the statement of work or project change, approved the statement of work for a program change (add, deletion, reorganization), reject the statement of work due to price versus budget, reject the statement of work for reasons other than pricing, or deny the statement of work and requests updates to the statement of work. At block 2930, the statement of work may be updated based on client feedback and the statement of work with incorporated client feedback may be sent to the client for review at block 2910.

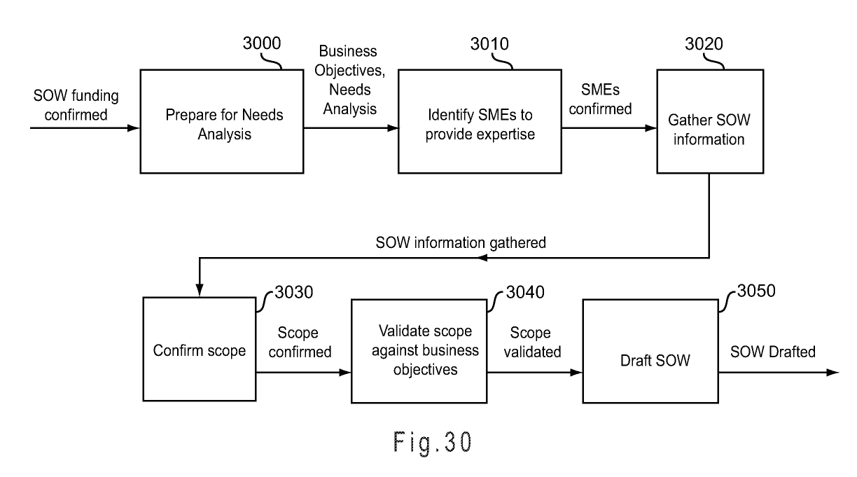

FIG. 30 is a block diagram to define needs, scope and statement of work. At block 3000, when statement of work funding is confirmed, a needs analysis is prepared. At block 3010, subject matter expert are identified to provide expertise based on business objectives and the needs analysis. At block 3020, statement of work information is gathered when the subject matter expert are confirmed. At block 3030, scope is confirmed when the statement of work information is gathered. At block 3040, scope is validated against business objectives when the scope is confirmed. At block 3050, the statement of work is drafted for the validated scope.

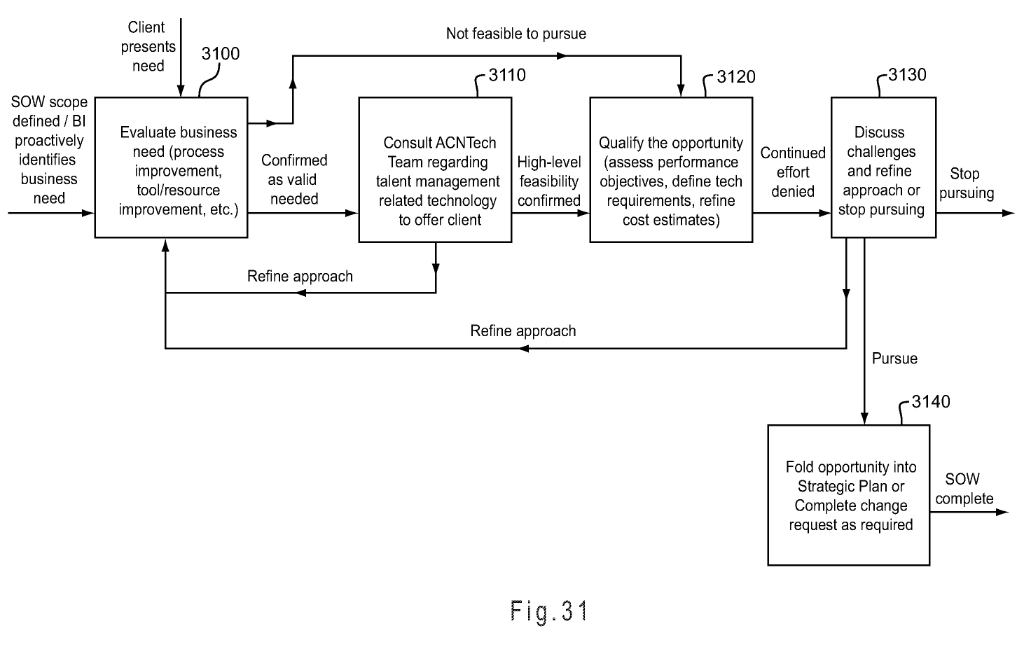

FIG. 31 is a block diagram to manage introduction and enhancements to technologies. At block 3100, business needs are evaluated, such as process improvement, tool/resource improvement, etc., in accordance with client presented needs, the defined statement of work scope, and business interlock proactively identified business needs. At block 3110, service provider is consulted regarding talent management related technology to offer the client for confirmed valid needs. At block 3120, for high-level confirmed feasibility, opportunities are qualified, such as assessed performance objectives, defined tech requirements, and refined cost estimates. At block 3130, for denied continued efforts or needs not feasible to pursue, challenges are discussed and approaches refined, or the need is no longer pursued. For consulting and discussed challenges, refined approaches may be evaluated at block 3100. At block 3140, for pursued needs, opportunities are folded into the strategic plan or change requests are completed as required, such as based on the implementation. Thereafter the statement of work is completed.

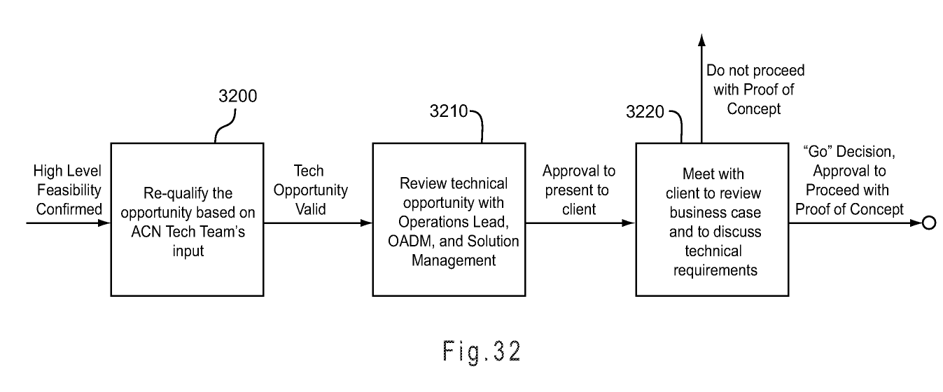

FIG. 32 is a block diagram of consulting the service provider regarding talent management related technology to offer the client. At block 3200, opportunities are re-qualified based on service provider's input for confirmed needs having a high level of feasibility. At block 3210, technical opportunities are reviewed with operation lead, account management and solution management for valid tech opportunities. At block 3220, for approval to present to the client, the service provider may meet with the client to review the business case and discuss technical requirements. In accordance with the meeting, the proof of concept is no pursued or is proceeded with, in accordance with whether there is approval from the client.

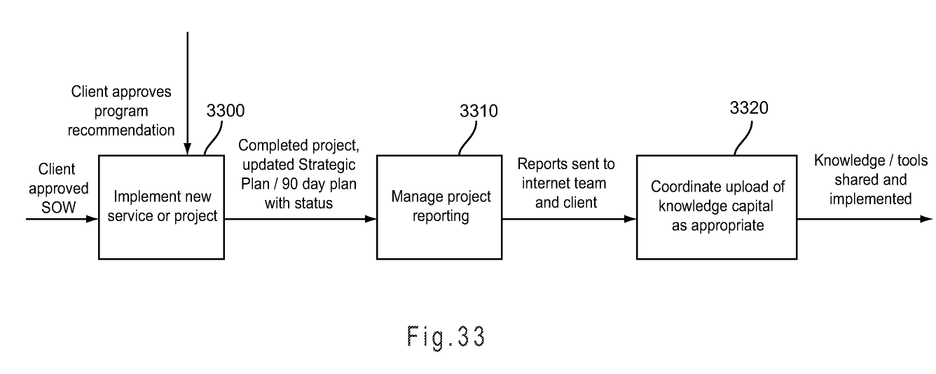

FIG. 33 is a block diagram of managing a project lifecycle and project reporting. At block 3300, new services or projects are implemented in accordance with client approved program recommendations and client approved statement of work. At block 3310, project reporting is managed based on completed projects and updated strategic plans and ninety plans with status. At block 3320, upload of knowledge capital is coordinated as appropriate for reports sent to internal teams and the client. Knowledge and tools are shared and implemented.

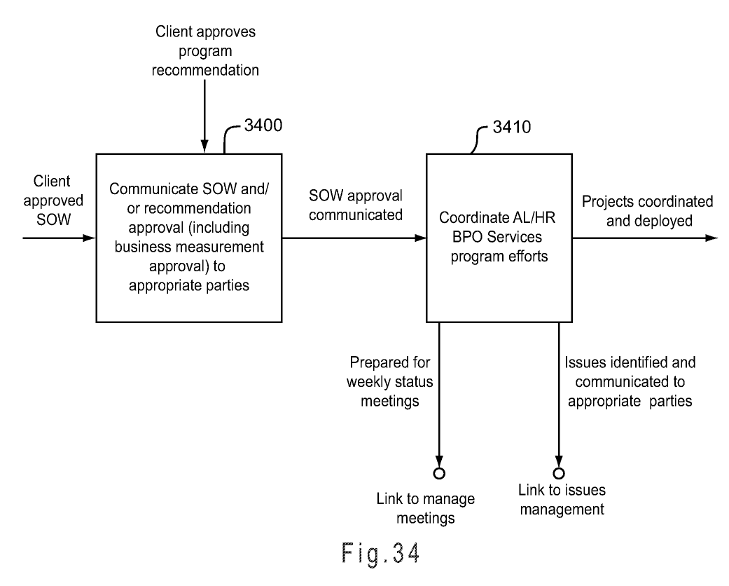

FIG. 34 is a block diagram of implementing a new service or project. At block 3400, statement of work and/or recommendation approval are communicated, including business measurement approval, to appropriate parties for client approved statement of work and program recommendations. At block 3410, AL/HR service provider service program efforts are coordinated when statement of work approval is communicated. Thereafter, projects are coordinated and deployed, issues are identified and communicated to appropriate parties, such as linking issues to management, and weekly status meeting are prepared for, and may be linked to managed meetings.

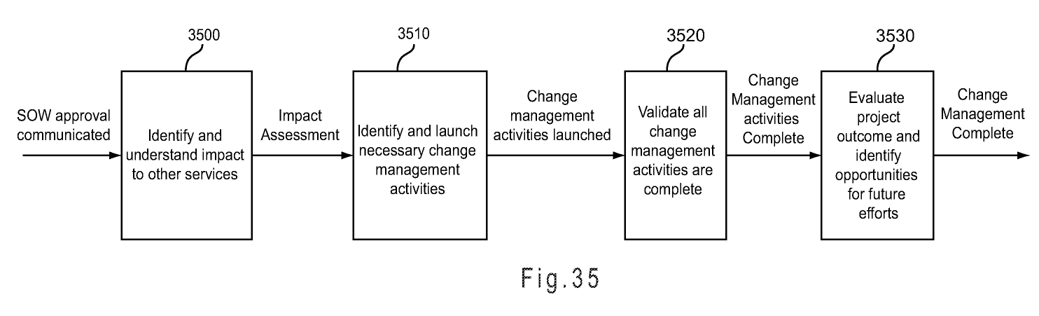

FIG. 35 is a block diagram of coordinated AL/HR service provider service program efforts. At block 3500, statement of work approval is communicated and the impact to other services is identifies and understood. At block 3510, necessary change to management activities is identified and launched for impact assessment. At block 3520, all changes to management activities are validated as complete for launched changed management activities. At block 3530, project outcomes are evaluated and opportunities identified for future efforts when the change management activities are complete. Thereafter, change management is complete.

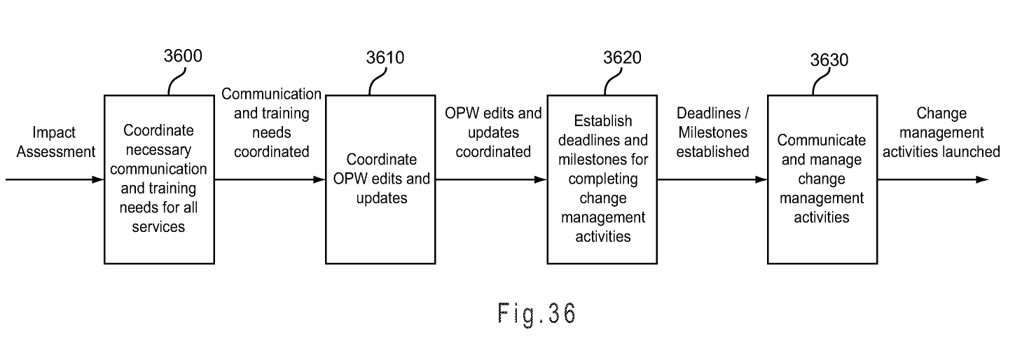

FIG. 36 is a block diagram to identify and launch necessary change management activities. At block 3610, necessary communication and training needs is coordinated for all services based on the impact assessment. At block 3610, standardized process flow edits and updates are completed after communication and training needs are coordinated. At block 3620, deadlines and milestones are established for completing change management activities when standardized process flow edits and updates are coordinated. At block 3630, change management activities are communicated and managed when the deadlines and milestones are established. Thereafter, the change management activities are launched.

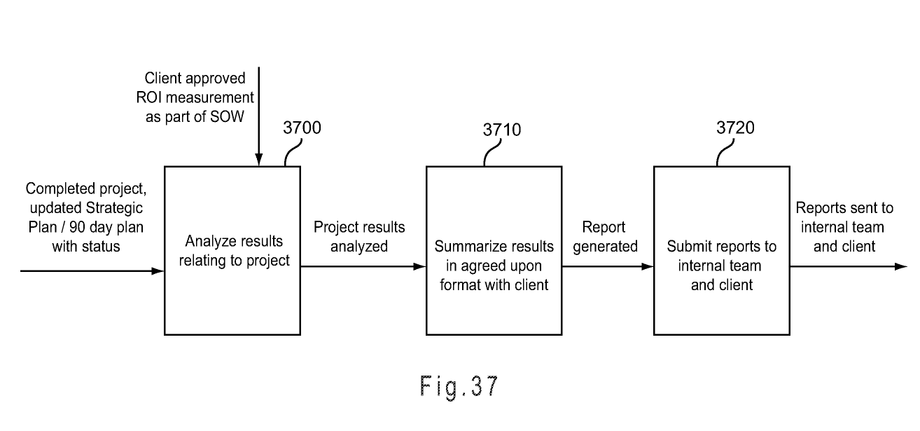

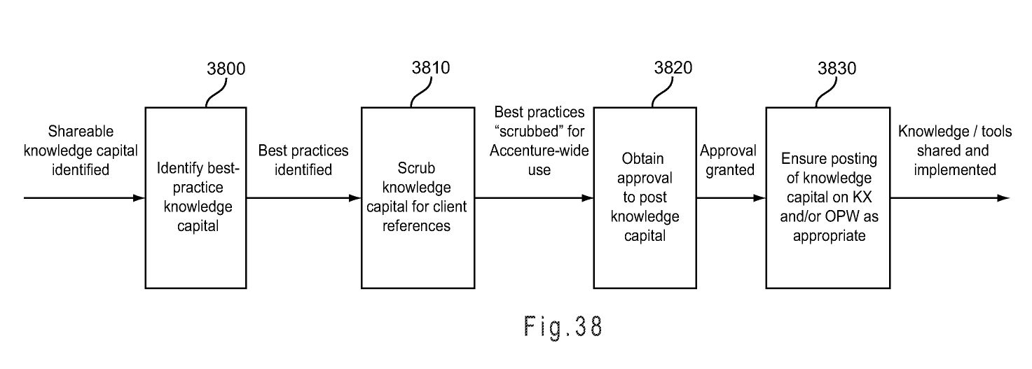

FIG. 37 is a block diagram of managing project reporting. At block 3700, results relating to the project are analyzed for client approved ROI measurement as part of statement of work and completed project, updated strategic plan and ninety day plan with status. At block 3710, results are summarized in an agreed upon format with the client after the project results are analyzed. At block 3720, generated reports are submitted to internal team clients. Reports are sent to the internal team and client. FIG. 38 is a block diagram of coordinating upload of knowledge capital, as appropriate. At block 3800, best practice knowledge capital is identified from shareable knowledge capital. At block 3810, knowledge capital for client references is scrubbed from the identified best practices. At block 3820, approval to post the knowledge capital is obtained for the best practices scrubbed for service provider use. At block 3830, posting of knowledge capital is ensured for the knowledge management system and/or standardized process flow, as appropriate, for knowledge capital approved for sharing. Thereafter, knowledge and tools may be shared an implemented.

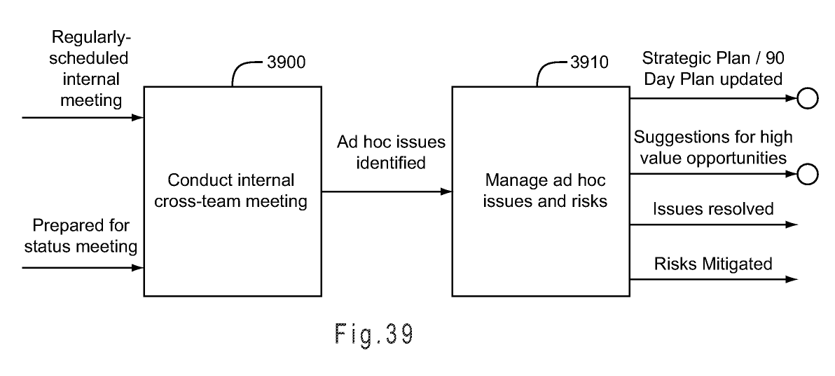

FIG. 39 is a block diagram for managing relationships and ad hoc issues. At block 3900, internal cross-team meeting may be conducted, such as based on regularly-scheduled internal meeting and prepared for status meetings. At block 3910, identified ad hoc issues and risks may be managed. Thereafter, strategic plans and ninety plans may be updated, suggestions may be given for high value opportunities, issues may be resolved and risks mitigated.

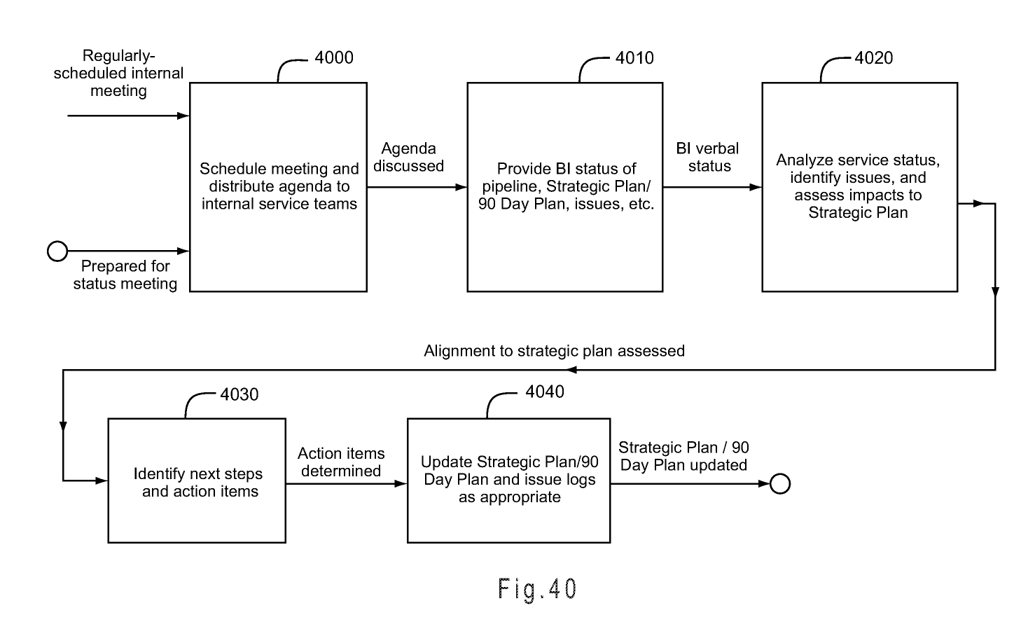

FIG. 40 is a block diagram for conducting internal cross-team meetings. At block 4000, meetings are scheduled and agendas distributed to internal service teams, such as for regularly-scheduled internal meeting and prepared for status meetings. At block 4010, business interlock status is provided for the service pipeline, the strategic plan, the ninety day plan, issues, etc. for the discussed agenda. At block 4020, the service status is analyzed, issued identified, and impact on the strategic plan analyzed. At block 4030, next steps and action items may be identified for an assessed alignment to the strategic plan. At block 4040, when action plans are determined, the strategic plan, ninety day plan and issue logs are updated, as appropriate.

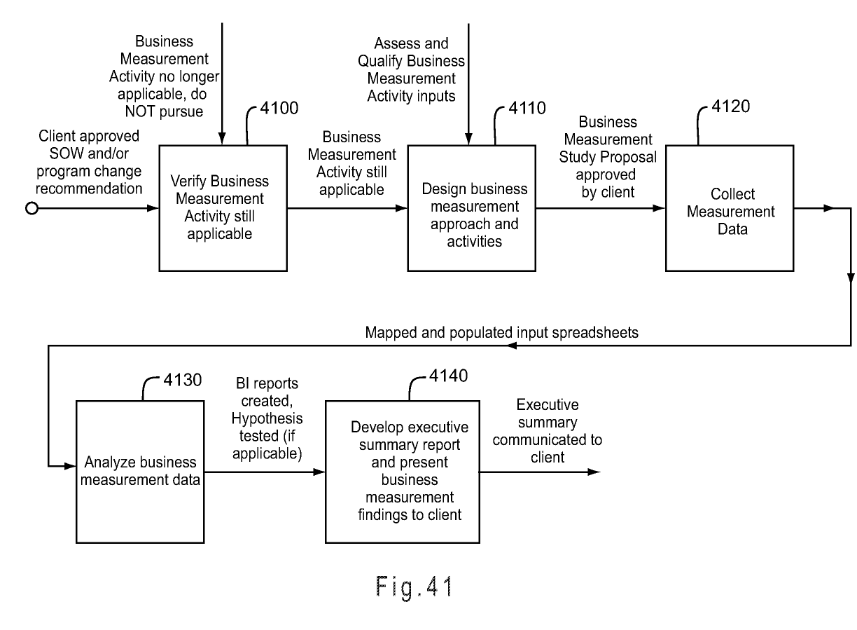

FIG. 41 is a block diagram for completing business measurement activities for selected projects. At block 4100, business measurement activities are verified as still being applicable for client approved statement of work and/or program change recommendations. Business measurement activities that are no longer applicable are not pursued. At block 4110, business measurement approaches and activities are designed for business measurement activities that are still applicable in accordance with business measurement activity inputs that are assessed and qualified. At block 4120, measurement data is collected for business measurement study proposals approved by the client. At block 4130, business measurement data is analyzed for mapped and populated input spreadsheets. At block 4140, executive summary reports are developed and business measurement finding are presented to the client after the business interlock reports are created and hypothesis tested, if applicable. Thereafter, an executive summary may be communicated to the client.

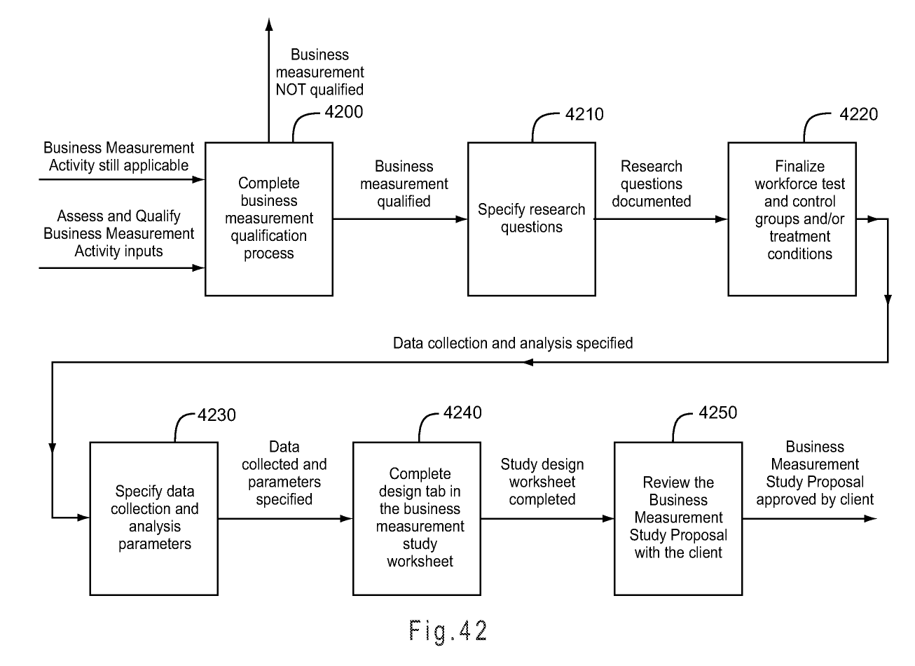

FIG. 42 is a block diagram to design business measurement approaches and activities. At block 4200, a business measurement qualification process is completed for business measurement activities that are still applicable and for business measurement activity inputs that have been assessed and qualified. At block 4210, research questions are specified for qualified business measurements. At block 4220, workforce test and control groups and/or treatment conditions are finalized for documented research questions. At block 4230, data collection and analysis parameters are specified. At block 4240, design tabs for the business measurement study worksheet may be completed for collected data and specified parameters. At block 4250, the business measurement study proposal may be reviewed with the client when the study design worksheet is completed, for attorney approval.

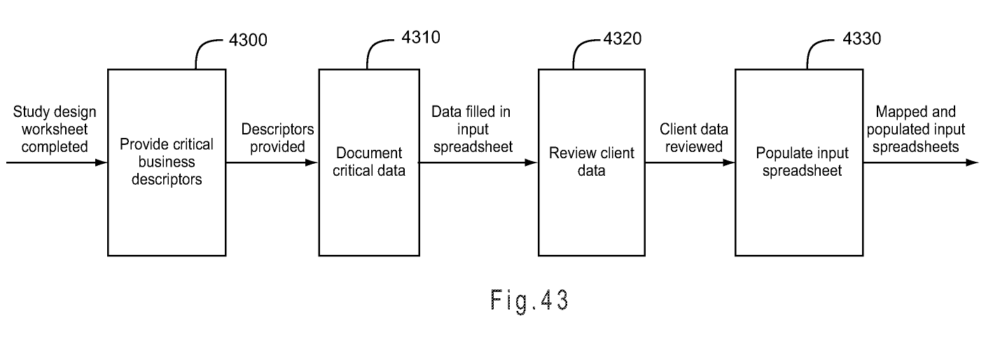

FIG. 43 is a block diagram with regard to collecting measured data. At block 4300, critical business descriptors may be provided based on the completed design worksheet. At block 4310, critical data may be documented for provided descriptors. At block 4320, client data may be reviewed based on the data filled in to the spreadsheets. At block 4330, the input spreadsheet may be populated bases on the reviewed client data. The spreadsheets may be mapped.

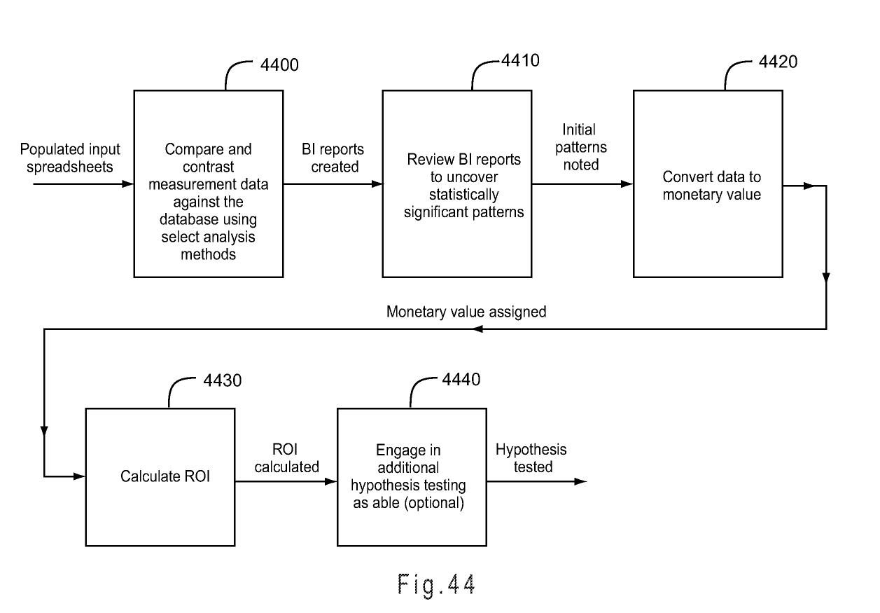

FIG. 44 is a block diagram to analyze business measurement data. At block 4400, measurement data is compared and contrasted against the database using selected analysis methods for the inputs populated into the spreadsheets. At block 4410, the created business interlock reports are reviewed to uncover statistically significant patterns. At block 4420, data is converted to monetary values for the initially noted patterns. At block 4430, ROI is calculated for the assigned monetary values. At block 4440, additional hypothesis testing may be conducted, if possible, for the calculated ROI.

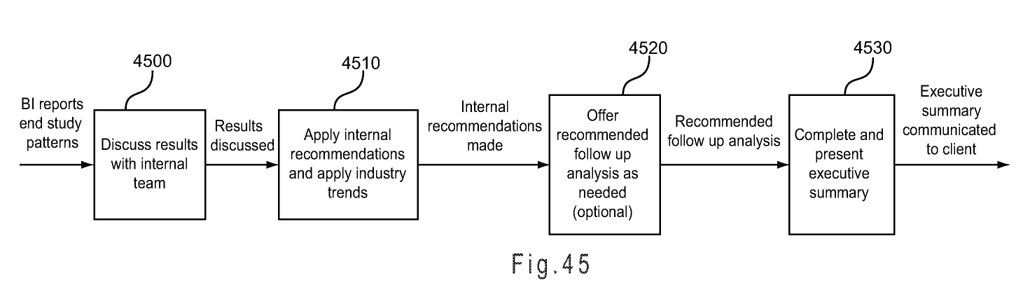

FIG. 45 is a block diagram for developing an executive summary report and presenting business measurement finding to clients. At block 4500, business interlock report and study pattern results may be discussed with the internal team. At block 4510, internal recommendations and industry trends may be applied based on the discussed results. At block 4520, recommended follow up based on the analysis may be offered as needed, when the internal recommendations are made. At block 4530, the executive summary may be completed and presented in accordance with the follow up analysis. Thereafter, the executive summary may be communicated to the client.

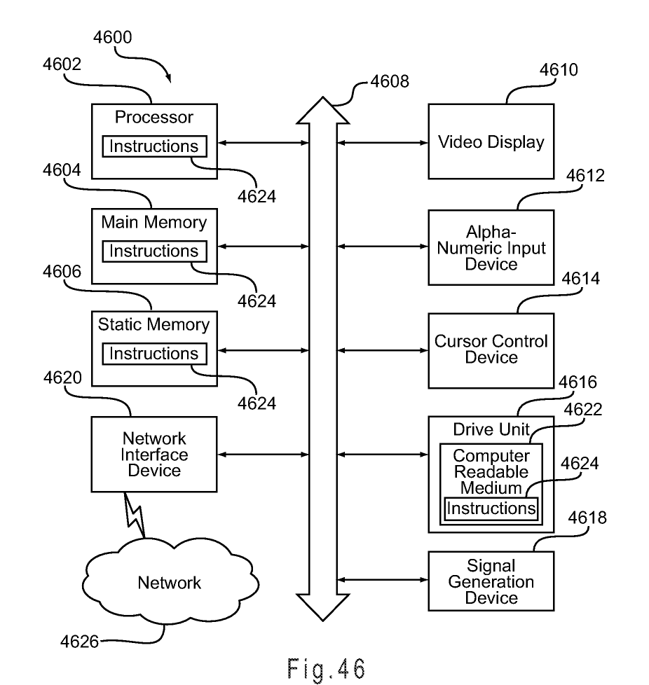

FIG. 46 is a block diagram of an exemplary general computer system 4600 that may be used to implement the business driven management tool and system. The computer system 4600 may include a set of instructions that can be executed to cause the computer system 4600 to perform any one or more of the methods or computer based functions disclosed herein. The computer system 4600 may operate as a standalone device or may be connected, e.g., using a network, to other computer systems or peripheral devices. The tool may be implemented hardware, software or firmware, or any combination thereof. Alternative software implementations may be used including, but not limited to, distributed processing or component/object distributed processing, parallel processing, or virtual machine processing may also be constructed to implement the tools described herein.

In a networked deployment, the computer system 4600 may operate in the capacity of a server or as a client user computer in a server-client user network environment, or as a peer computer system in a peer-to-peer (or distributed) network environment. The computer system 4600 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, or any other machine capable of executing a set of instructions (sequential or otherwise) that specify actions to be taken by that machine. The computer system 4600 may be implemented using electronic devices that provide voice, video or data communication. Further, while a single computer system 4600 is illustrated, the term “system” shall also be taken to include any collection of systems or sub-systems that individually or jointly execute a set, or multiple sets, of instructions to perform one or more computer functions.

The computer system 4600 may include a processor 4602, e.g., a central processing unit (CPU), a graphics processing unit (GPU), or both. Moreover, the computer system 4600 may include a main memory 4604 and a static memory 4606 that may communicate with each other via a bus 4608. The computer system 4600 may further include a video display unit 4610, such as a liquid crystal display (LCD), an organic light emitting diode (OLED), a flat panel display, a solid state display, or a cathode ray tube (CRT). Additionally, the computer system 4600 may include an input device 4612, such as a keyboard, and a cursor control device 4614, such as a mouse. The computer system 4600 may also include a disk drive unit 4616, a signal generation device 4618, such as a speaker or remote control, and a network interface device 4620.

The disk drive unit 4616 may include a computer-readable medium 4622 in which one or more sets of instructions 4624, e.g. software, may be embedded. Further, the instructions 4624 may embody one or more of the methods or logic as described herein. In a particular embodiment, the instructions 4624 may reside completely, or at least partially, within the main memory 4604, the static memory 4606, and/or within the processor 4602 during execution by the computer system 4600. The main memory 4604 and the processor 4602 also may include computer-readable media.

Dedicated hardware implementations, such as application specific integrated circuits, programmable logic arrays and other hardware devices, may be constructed to implement one or more of the tools described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit.

The present disclosure contemplates a computer-readable medium that includes instructions 4624 or receives and executes instructions 4624 responsive to a propagated signal, so that a device connected to a network 4626 may communicate voice, video or data over the network 4626. Further, the instructions 4624 may be transmitted or received over the network 4626 via the network interface device 4620. While the computer-readable medium is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding or carrying a set of instructions for execution by a processor or that cause a computer system to perform any one or more of the methods or operations disclosed herein.

The computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A computer implemented method for a business driven management, comprising:
providing a strategic alignment of a plurality of services;
driving demand planning in accordance with the strategic alignment;
outputting program execution and value measurement in accordance with the demand planning; and
applying program execution and value measurement in accordance with the strategic alignment.

2. The method of claim 1 wherein providing the strategic alignment comprises:
determining a strategic direction;
assessing client opportunities to provide increased value to the strategic direction; and
responding to the client opportunities.

3. The method of claim 2 further comprising setting a measurement program.

4. The method of claim 3 further comprising establishing the strategic direction in accordance with the measurement program.

5. The method of claim 2 wherein providing the strategic alignment further comprises conducting innovation workshops to identify innovation initiatives and opportunities.

6. The method of claim 1 wherein demand planning further comprises creating a strategic plan and a second plan, the second plan having a shorter time period than that strategic plan.

7. The method of claim 6 wherein the second plan is based on the strategic plan.

8. The method of claim 6 further comprising validating the strategic plan against business objectives and the second plan against available resources.

9. The method of claims 1 wherein applying value measurement further comprises collecting measurement data regarding lessons learned from the applied program execution.

10. The method of claim 9 further comprising providing to the strategic alignment the data regarding lessons learned.

11. A system for a business driven management, comprising:
a computer processor for executing programmed code stored in a memory, the code:
to provide a strategic alignment of a plurality of services;
to drive demand planning in accordance with the strategic alignment;
to output program execution and value measurement in accordance with the demand planning; and
to apply program execution and value measurement in accordance with the strategic alignment.

12. The system of claim 11 wherein providing the strategic alignment comprises:
determining a strategic direction;
assessing client opportunities to provide increased value to the strategic direction; and
responding to the client opportunities.

13. The system of claim 12 further comprising setting a measurement program.

14. The system of claim 13 further comprising establishing the strategic direction in accordance with the measurement program.

15. The system of claim 12 wherein providing the strategic alignment further comprises conducting innovation workshops to identify innovation initiatives and opportunities.

16. The system of claim 11 wherein demand planning further comprises creating a strategic plan and a second plan, the second plan having a shorter time period than that strategic plan.

17. The system of claim 16 wherein the second plan is based on the strategic plan.

18. The system of claim 16 further comprising validating the strategic plan against business objectives and the second plan against available resources.

19. The system of claims 11 wherein applying value measurement further comprises collecting measurement data regarding lessons learned from the applied program execution.

20. The system of claim 19 further comprising providing to the strategic alignment the data regarding lessons learned.
